(19) United States
(12) Patent Application Publication
(10) Pub. No.: US 2022/0258570 A1
(43) Pub. Date: Aug. 18, 2022

(54) TEMPERATURE ADJUSTMENT DEVICE FOR VEHICLE-MOUNTED HEAT-GENERATING EQUIPMENT AND VEHICLE AIR CONDITIONER PROVIDED WITH SAME

(71) Applicant: SANDEN AUTOMOTIVE CLIMATE SYSTEMS CORPORATION, Isesaki-shi, Gunma (JP)

(72) Inventor: Tetsuya ISHIZEKI, Isesaki-shi, Gunma (JP)

(73) Assignee: SANDEN AUTOMOTIVE CLIMATE SYSTEMS CORPORATION, Isesaki-shi, Gunma (JP)

(21) Appl. No.: 17/626,743

(22) PCT Filed: Jul. 17, 2020
(86) PCT No.: PCT/JP2020/027796

§ 371 Date: Jan. 12, 2022

(30) Foreign Application Priority Data
Aug. 6, 2019 (JP) 2019-144086

(51) Int. Cl. B60H 1/14; B60L 58/24

(52) U.S. Cl. CPC B60H 1/143; B60L 58/24

(57) ABSTRACT

A temperature adjustment device for vehicle-mounted heat-generating equipment is provided which, without cooling units respectively corresponding to low heat-generating equipment and high heat-generating equipment mounted on a vehicle, enables temperature adjustment of each heat-generating equipment to be executed without hindrance. The temperature adjustment device adjusts the temperatures of a battery 55 and a motor 65 for running both mounted on the vehicle, and includes a heat medium circulation circuit 60 for circulating a heat medium to the battery 55 and the motor 65 for running, and a refrigerant-heat medium heat exchanger 64 for cooling the heat medium circulated through the heat medium circulation circuit 60. The heat medium cooled in the refrigerant-heat medium heat exchanger 64 flows through the battery 55 and then flows to the motor 65 for running.

### CROSS-REFERENCE TO RELATED APPLICATIONS

This application is a U.S. National Stage Patent Application under 37 U.S.C. § 371 of International Patent Application No. PCT/JP2020/027796, filed on Jul. 17, 2020, which claims the benefit of Japanese Patent Application No. JP 2019-144086, filed on Aug. 6, 2019, the disclosures of each of which are incorporated herein by reference in their entirety.

### TECHNICAL FIELD

The present invention relates to a temperature adjustment device for adjusting the temperature of heat-generating equipment mounted on a vehicle, and a vehicle air conditioner provided with the same.

### BACKGROUND ART

Due to actualization of environmental problems in recent years, vehicles such as hybrid cars and electric vehicles each of which drives a motor for running by power supplied from a battery mounted on the vehicle have spread. Further, as an air conditioning device which is applicable to such vehicles, there has been developed an air conditioning device which includes a refrigerant circuit to which a compressor, a radiator, a heat absorber, and an outdoor heat exchanger are connected, and which lets a refrigerant discharged from the compressor radiate heat in the radiator and lets the refrigerant from which the heat has been radiated in the radiator absorb heat in the outdoor heat exchanger to thereby heat a vehicle interior, and which lets the refrigerant discharged from the compressor radiate heat in the outdoor heat exchanger and lets the refrigerant absorb heat in the heat absorber to thereby cool the vehicle interior (refer to, for example, Patent Document 1).

On the other hand, the charge/discharge performance of the battery (vehicle-mounted heat-generating equipment) is lowered under a low temperature environment. Further, there is also a risk that when the charging/discharging of the battery is performed under an environment where the temperature becomes high due to self-heat generation or the like, its deterioration progresses and soon the battery causes an operation failure to lead to breakage. Therefore, there has also been developed a battery in which the temperature thereof can be adjusted by circulating cooling water (heat medium) that exchanges heat with a refrigerant circulated through a refrigerant circuit to the battery (refer to, for example, Patent Document 2).

### CITATION LIST

### Patent Documents

Patent Document 1: Japanese Patent Application Laid-Open No. 2014-213765
Patent Document 2: Japanese Patent No. 5440426

### SUMMARY OF THE INVENTION

### Problems to be Solved by the Invention

By cooling the battery as described above, it is possible to recover waste heat of the battery to the refrigerant via the cooling water and contribute to the heating of the vehicle interior while preventing deterioration of the battery due to an abnormal high temperature of the battery. On the other hand, a problem arises in that even in addition to the battery, the vehicle is also equipped with the above-mentioned motor for running (vehicle-mounted heat-generating equipment), etc., and these running motor and the like are also driven to generate heat, so that waste heat can be recovered, but since the motor for running (high heat-generating equipment) is higher in the heat generation temperature than the battery (low heat-generating equipment) (the heat generation temperature in this application is assumed to be the maximum temperature at the time of heat generation), a heat exchanger (cooling unit) for exchanging heat between the refrigerant and the heat medium becomes necessary to absorb heat from each of the motor for running and the battery.

The present invention has been made to solve such conventional technical problems and aims to provide a temperature adjustment device for vehicle-mounted heat-generating equipment which, without providing cooling units respectively corresponding to low heat-generating equipment and high heat-generating equipment mounted on a vehicle, makes it possible to perform temperature adjustment of each heat-generating equipment without hindrance, and a vehicle air conditioner provided with the temperature adjustment device.

### Means for Solving the Problems

A temperature adjustment device for vehicle-mounted heat-generating equipment of the present invention adjusts the temperatures of low heat-generating equipment mounted on a vehicle and high heat-generating equipment higher in heat generation temperature than the low heat-generating equipment and is characterized by including a heat medium circulation circuit to circulate a heat medium through the low heat-generating equipment and the high heat-generating equipment, and a cooling unit to cool the heat medium circulating through the heat medium circulation circuit, and in that the heat medium cooled in the cooling unit flows through the low heat-generating equipment and then flows to the high heat-generating equipment.

The temperature adjustment device for the vehicle-mounted heat-generating equipment of the invention of claim 2 is characterized in the above invention by including a first bypass passage to bypass the high heat-generating equipment to allow the heat medium passed through low heat-generating equipment to flow to the cooling unit, a first flow passage changing device to change whether the heat medium passed through the low heat-generating equipment is made to flow to the high heat-generating equipment or made to flow through the first bypass passage, and a control device to control the first flow passage changing device, and in that the control device has a first circulation mode in which the heat medium cooled by the cooling unit is passed through the low heat-generating equipment and then passed through the high heat-generating equipment, and a second circulation mode in which the heat medium cooled by the cooling unit is passed through the low heat-generating equipment and then passed through the first bypass passage.

The temperature adjustment device for the vehicle-mounted heat-generating equipment of the invention of claim 3 is characterized in the above invention by including an air-heat medium heat exchanger to exchange heat between outdoor air and the heat medium, and a second flow passage changing device controlled by the control device and to change whether the heat medium passed through the high heat-generating equipment is made to flow to the cooling unit or made to flow to the air-heat medium heat exchanger, and in that the control device has a third circulation mode to circulate the heat medium between the high heat-generating equipment and the air-heat medium heat exchanger.

The temperature adjustment device for the vehicle-mounted heat-generating equipment of the invention of claim 4 is characterized in the invention of claim 2 or 3 by including a second bypass passage to bypass the low heat-generating equipment to allow the heat medium passed through the cooling unit to flow to the high heat-generating equipment, and a third flow passage changing device controlled by control device and to change whether the heat medium passed through the cooling unit is made to flow to the low heat-generating equipment or made to flow through the second bypass passage, and in that the control device has a fourth circulation mode to circulate the heat medium between the high heat-generating equipment and the cooling unit.

The temperature adjustment device for the vehicle-mounted heat-generating equipment of the invention of claim 5 is characterized in claims 2 to 4 by including a heating unit controlled by the control device and to heat the heat medium flowing into the low heat-generating equipment.

The temperature adjustment device for the vehicle-mounted heat-generating equipment of the invention of claim 6 is characterized in the above invention by including a third bypass passage to bypass the first bypass passage and the cooling unit, and a fourth flow passage changing device controlled by the control device and to change whether the heat medium passed through the low heat-generating equipment is made to flow through the first bypass passage or made to flow through the third bypass passage, and in that the control device has a fifth circulation mode to circulate the heat medium between the low heat-generating equipment and the heating unit.

The temperature adjustment device for the vehicle-mounted heat-generating equipment of the invention of claim 7 is characterized in claim 5 or 6 by including a heater core to heat air supplied to a vehicle interior, a fourth bypass passage to bypass the low heat-generating equipment to allow the heat medium passed through the heating unit to flow to the heater core, and a fifth flow passage changing device controlled by control device and to change whether the heat medium passed through the heating unit is made to flow to the low heat-generating equipment or made to flow through the fourth bypass passage, and in that the control device has a sixth circulation mode to circulate the heat medium between the heater core and the heating unit.

The temperature adjustment device for the vehicle-mounted heat-generating equipment of the invention of claim 8 is characterized in the above respective inventions by including a refrigerant circuit having a compressor to compress a refrigerant, a heat exchanger for radiation to let the refrigerant discharged from the compressor radiate heat, and a refrigerant-heat medium heat exchanger as the cooling unit to let the refrigerant from which the heat has been radiated in the heat exchanger for radiation, absorb heat to thereby cool the heat medium.

A vehicle air conditioner of the invention of claim 9 is characterized by having a temperature adjustment device for vehicle-mounted heat-generating equipment according to claim 2, 4, or 5, and a refrigerant circuit including a compressor to compress a refrigerant, a radiator to let the refrigerant radiate heat to heat air supplied to a vehicle interior, and a refrigerant-heat medium heat exchanger as the cooling unit to let the refrigerant absorb heat to cool the heat medium, and in that the control device makes it possible to execute a heating operation of letting the refrigerant discharged from the compressor radiate heat in the radiator to heat the vehicle interior, and in the heating operation, the control device allows at least a part of the refrigerant from which the heat has been radiated in the radiator to flow through the refrigerant-heat medium heat exchanger and executes the first circulation mode, the second circulation mode, or the fourth circulation mode.

A vehicle air conditioner of the invention of claim 10 is characterized by having a temperature adjustment device for vehicle-mounted heat-generating equipment according to claim 2, and a refrigerant circuit including a compressor to compress a refrigerant, a heat absorber to let the refrigerant absorb heat to cool air supplied to a vehicle interior, an outdoor heat exchanger provided outside the vehicle interior, and a refrigerant-heat medium heat exchanger as the cooling unit to let the refrigerant absorb heat to cool the heat medium, and in that the control device makes it possible to execute a cooling operation of letting the refrigerant discharged from the compressor radiate heat in the outdoor heat exchanger, decompressing the refrigerant from which the heat has been radiated, and then letting the refrigerant absorb heat in the heat absorber to cool the vehicle interior, and in the cooling operation, the control device allows at least a part of the refrigerant from which the heat has been radiated in the outdoor heat exchanger to flow through the refrigerant-heat medium heat exchanger and executes the second circulation mode.

### Advantageous Effect of the Invention

A temperature adjustment device for vehicle-mounted heat-generating equipment of the present invention adjusts the temperatures of low heat-generating equipment mounted on a vehicle and high heat-generating equipment higher in heat generation temperature than the low heat-generating equipment. In the temperature adjustment device, there are provided a heat medium circulation circuit to circulate a heat medium through the low heat-generating equipment and the high heat-generating equipment, and a cooling unit to cool the heat medium circulating through the heat medium circulation circuit. Therefore, it is possible to cool the low heat-generating equipment and the high heat-generating equipment through the heat medium by the cooling unit and adjust their temperatures.

Here, when the heat medium cooled by the cooling unit is made to flow from the high heat-generating equipment to the low heat-generating equipment, the heat medium whose temperature has risen due to heat exchange by the high heat-generating equipment flows to the low heat-generating equipment. There is therefore a risk that the low heat-generating equipment will be heated by the high heat-generating equipment via the heat medium. However, in the present invention, the heat medium cooled by the cooling unit passes through the low heat-generating equipment and then flows to the high heat-generating equipment, so that such a problem is solved, and both the low heat-generating equipment and the high heat-generating equipment can be cooled without hindrance by the single cooling unit.

Also, in addition to the above invention, the temperature adjustment device for the vehicle-mounted heat-generating equipment of the invention of claim 2 includes a first bypass passage to bypass the high heat-generating equipment to allow the heat medium passed through low heat-generating equipment to flow to the cooling unit, a first flow passage changing device to change whether the heat medium passed through the low heat-generating equipment is made to flow to the high heat-generating equipment or made to flow through the first bypass passage, and a control device to control the first flow passage changing device The control device has a first circulation mode in which the heat medium cooled by the cooling unit is passed through the low heat-generating equipment and then passed through the high heat-generating equipment, and a second circulation mode in which the heat medium cooled by the cooling unit is passed through the low heat-generating equipment and then passed through the first bypass passage. Therefore, when there is a need to cool both the low heat-generating equipment and the high heat-generating equipment by the cooling unit, the control device executes the first circulation mode. When there is a need to cool the low heat-generating equipment and there is no need to cool the high heat-generating equipment, the control device executes the second circulation mode, whereby it becomes possible to effectively adjust the temperatures of each heat-generating equipment by cooling only the low heat-generating equipment by the cooling unit.

Further, in addition to the above invention, the temperature adjustment device for the vehicle-mounted heat-generating equipment of the invention of claim 3 includes an air-heat medium heat exchanger to exchange heat between outdoor air and the heat medium, and a second flow passage changing device controlled by the control device and to change whether the heat medium passed through the high heat-generating equipment is made to flow to the cooling unit or made to flow to the air-heat medium heat exchanger. The control device has a third circulation mode to circulate the heat medium between the high heat-generating equipment and the air-heat medium heat exchanger. Therefore, for example, when there is a need to perform cooling of the high heat-generating equipment in a state in which the temperature of the low heat-generating equipment is adjusted by the cooling unit in the second circulation mode, the control device executes the third circulation mode, thereby making it also possible to cool the high heat-generating equipment by the outdoor air through the heat medium.

In addition, in the invention of claim 2 or 3, the temperature adjustment device for the vehicle-mounted heat-generating equipment of the invention of claim 4 includes a second bypass passage to bypass the low heat-generating equipment to allow the heat medium passed through the cooling unit to flow to the high heat-generating equipment, and a third flow passage changing device controlled by control device and to change whether the heat medium passed through the cooling unit is made to flow to the low heat-generating equipment or made to flow through the second bypass passage. The control device has a fourth circulation mode to circulate the heat medium between the high heat-generating equipment and the cooling unit. Therefore, when there is a need to cool the high heat-generating equipment and there is no need to cool the low heat-generating equipment, the control device executes the fourth circulation mode, whereby it becomes also possible to cool only the high heat-generating equipment by the cooling unit.

Furthermore, in addition to claims 2 to 4, the temperature adjustment device for the vehicle-mounted heat-generating equipment of the invention of claim 5 includes a heating unit controlled by the control device and to heat the heat medium flowing into the low heat-generating equipment. Therefore, the heating unit heats the heat medium flowing into the low heat-generating equipment, thereby making it possible to heat the low heat-generating equipment. Thus, it becomes possible to adjust the low heat-generating equipment to an appropriate temperature in an environment where the temperature of the low heat-generating equipment becomes low.

In this case, for example, as in the invention of claim 6, if there are further provided a third bypass passage to bypass the first bypass passage and the cooling unit, and a fourth flow passage changing device controlled by the control device and to change whether the heat medium passed through the low heat-generating equipment is made to flow through the first bypass passage or made to flow through the third bypass passage, and the control device has a fifth circulation mode to circulate the heat medium between the low heat-generating equipment and the heating unit, it becomes possible to smoothly heat the low heat-generating equipment by the heating unit by executing the fifth circulation mode.

Further, as in the invention of claim 7, if there are further provided a heater core to heat air supplied to a vehicle interior, a fourth bypass passage to bypass the low heat-generating equipment to allow the heat medium passed through the heating unit to flow to the heater core, and a fifth flow passage changing device controlled by control device and to change whether the heat medium passed through the heating unit is made to flow to the low heat-generating equipment or made to flow through the fourth bypass passage, and the control device has a sixth circulation mode to circulate the heat medium between the heater core and the heating unit, the heat medium heated by the heating unit is circulated to the heater core by the sixth circulation mode when there is no need to heat the low heat-generating equipment, thereby making is possible to heat the vehicle interior by the heating unit through the heat medium.

Moreover, in addition to the above respective inventions, the temperature adjustment device for the vehicle-mounted heat-generating equipment of the invention of claim 8 includes a refrigerant circuit having a compressor to compress a refrigerant, a heat exchanger for radiation to let the refrigerant discharged from the compressor radiate heat, and a refrigerant-heat medium heat exchanger to let the refrigerant from which the heat has been radiated in the heat exchanger for radiation, absorb heat. Therefore, by cooling the heat medium with the refrigerant-heat medium heat exchanger as the cooling unit, the low heat-generating equipment and the high heat-generating equipment can be smoothly cooled by a so-called heat pump operation using the refrigerant circuit.

Then, a vehicle air conditioner of the invention of claim 9 includes a temperature adjustment device for vehicle-mounted heat-generating equipment according to claim 2, 4, or 5, and a refrigerant circuit having a compressor to compress a refrigerant, a radiator to let the refrigerant radiate heat to heat air supplied to a vehicle interior, and a refrigerant-heat medium heat exchanger as the cooling unit to let the refrigerant absorb heat to cool the heat medium. The control device makes it possible to execute a heating operation of letting the refrigerant discharged from the compressor radiate heat in the radiator to heat the vehicle interior, and in the heating operation, the control device allows at least a part of the refrigerant from which the heat has been radiated in the radiator to flow through the refrigerant-heat medium heat exchanger and executes the first circulation mode, the second circulation mode, or the fourth circulation mode. Therefore, in the first circulation mode, waste heat is recovered from both of the low heat-generating equipment and the high heat-generating equipment, in the second circulation mode, waste heat is recovered only from the low heat-generating equipment, and in the fourth circulation mode, waste heat is recovered only from the high heat-generating equipment to be transferred to the radiator, thereby making it possible to heat the vehicle interior.

Further, when the heating unit is provided as in the invention of claim 5, the heat medium is heated by this heating unit, and the second circulation mode is executed, whereby the heat from the heating unit can also be transferred to the radiator and contribute to the heating of the vehicle interior.

In addition, a vehicle air conditioner of the invention of claim 10 includes a temperature adjustment device for vehicle-mounted heat-generating equipment according to claim 2, and a refrigerant circuit having a compressor to compress a refrigerant, a heat absorber to let the refrigerant absorb heat to cool air supplied to a vehicle interior, an outdoor heat exchanger provided outside the vehicle interior, and a refrigerant-heat medium heat exchanger as the cooling unit to let the refrigerant absorb heat to cool the heat medium. The control device makes it possible to execute a cooling operation of letting the refrigerant discharged from the compressor radiate heat in the outdoor heat exchanger, decompressing the refrigerant from which the heat has been radiated, and then letting the refrigerant absorb heat in the heat absorber to cool the vehicle interior. In the cooling operation, the control device allows at least a part of the refrigerant from which the heat has been radiated in the outdoor heat exchanger to flow through the refrigerant-heat medium heat exchanger and executes the second circulation mode. Therefore, the cooling of the low heat-generating equipment can also be performed while performing the cooling of the vehicle interior.

### BRIEF DESCRIPTION OF THE DRAWINGS

FIG. 1 is a constitutional diagram of one embodiment of a vehicle air conditioner to which the present invention is applied (first circulation mode in heating operation);

FIG. 2 is a block diagram of an air conditioning controller as a control device of the vehicle air conditioner of FIG. 1;

FIG. 3 is a diagram describing a second circulating mode in a heating operation by the air conditioning controller of FIG. 2;

FIG. 4 is a diagram describing the second circulating mode in the cooling operation by the air conditioning controller of FIG. 2;

FIG. 5 is a diagram describing a third circulating mode by the air conditioning controller of FIG. 2;

FIG. 6 is a diagram describing a fourth circulating mode in the heating operation by the air conditioning controller of FIG. 2;

FIG. 7 is a diagram describing a fifth circulating mode by the air conditioning controller of FIG. 2;

FIG. 8 is a diagram describing the second circulating mode+the third circulating mode by the air conditioning controller of FIG. 2;

FIG. 9 is a diagram describing a sixth circulating mode by the air conditioning controller of FIG. 2; and

FIG. 10 is a flowchart describing changing control of circulating modes of a heating medium by the air conditioning controller of FIG. 2.

### MODE FOR CARRYING OUT THE INVENTION

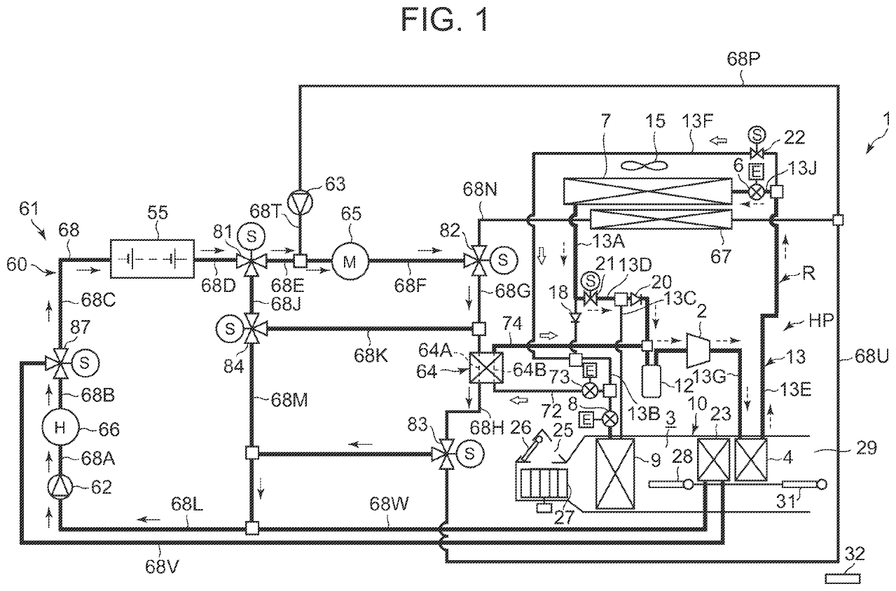

Hereinafter, description will be made as to embodiments of the present invention in detail with reference to the drawings. FIG. 1 illustrates a constitutional diagram of a vehicle air conditioner 1 of an embodiment to which the present invention is applied. A vehicle of the embodiment to which the present invention is applied is an electric vehicle (EV) in which an engine (an internal combustion engine) is not mounted, and is mounted with a battery 55 (e.g., a lithium battery) and runs with a motor for running (an electric motor) 65 which is driven by being supplied with power charged in the battery 55 from an external power supply. Further, the vehicle air conditioner 1 is also driven by being supplied with power from the battery 55.

That is, in the electric vehicle which is not capable of performing heating by engine waste heat, the vehicle air conditioner 1 performs a heating operation by a heat pump device HP having a refrigerant circuit R. Further, the vehicle air conditioner 1 selectively executes respective air conditioning operations of a dehumidifying and heating operation, a dehumidifying and cooling operation, and a cooling operation to perform air conditioning of a vehicle interior. Incidentally, the vehicle is not limited to such an electric vehicle, and it is needless to say that the present invention is also effective for a so-called hybrid car in which the engine is used together with the electric motor for running.

The vehicle air conditioner 1 of the embodiment performs air conditioning (heating, cooling, dehumidifying, and ventilation) of the vehicle interior of the electric vehicle. An electric type of compressor 2 (electric compressor) 2 to compress a refrigerant, a radiator 4 as a heat exchanger for radiation, which is provided in an air flow passage 3 of an HVAC unit 10 in which air in the vehicle interior is ventilated and circulated, to let the high-temperature high-pressure refrigerant discharged from the compressor 2 flow therein via a refrigerant pipe 13G and to let the refrigerant radiate heat to heat the air supplied to the vehicle interior, an outdoor expansion valve 6 constituted of an electric valve which decompresses and expands the refrigerant during the heating, an outdoor heat exchanger 7 which performs heat exchange between the refrigerant and outdoor air to function as a heat exchanger (condenser) for radiation to let the refrigerant radiate heat during the cooling and to function as an evaporator to let the refrigerant absorb heat during the heating, an indoor expansion valve 8 constituted of an electric valve to decompress and expand the refrigerant, a heat absorber 9 provided in the air flow passage 3 to let the refrigerant absorb heat during the cooling (during dehumidifying) from interior and exterior of the vehicle to cool the air supplied to the vehicle interior, an accumulator 12, and others are successively connected by a refrigerant pipe 13, whereby a refrigerant circuit R of the heat pump device HP is constituted. The outdoor expansion valve 6 and the indoor expansion valve 8 decompress and expand the refrigerant and enable fully closing and fully opening as well.

Incidentally, an outdoor blower 15 is provided in the outdoor heat exchanger 7. The outdoor blower 15 forcibly passes the outdoor air through the outdoor heat exchanger 7 to thereby perform heat exchange between the outdoor air and the refrigerant, whereby the outdoor air is made to pass through the outdoor heat exchanger 7 even during stopping of the vehicle (i.e., its velocity is 0 km/h).

Further, a refrigerant pipe 13A connected to a refrigerant outlet side of the outdoor heat exchanger 7 is connected to a refrigerant pipe 13B via a check valve 18. Incidentally, the check valve 18 has a refrigerant pipe 13B side which serves as a forward direction. The refrigerant pipe 13B is connected to the indoor expansion valve 8.

In addition, the refrigerant pipe 13A extending out from the outdoor heat exchanger 7 branches and this branching refrigerant pipe 13D communicates and connects with a refrigerant pipe 13C located on an outlet side of the heat absorber 9 via a solenoid valve 21 to be opened during the heating. Then, a check valve 20 is connected to the refrigerant pipe 13C on a downstream side from a point to which the refrigerant pipe 13D is connected. The refrigerant pipe 13C on the downstream side from the check valve 20 is connected to the accumulator 12. The accumulator 12 is connected to a refrigerant suction side of the compressor 2. Incidentally, the check valve 20 has an accumulator 12 side which serves as a forward direction.

Furthermore, a refrigerant pipe 13E on an outlet side of the radiator 4 branches to a refrigerant pipe 13J and a refrigerant pipe 13F before the outdoor expansion valve 6 (on a refrigerant upstream side). One branching refrigerant pipe 13J is connected to a refrigerant inlet side of the outdoor heat exchanger 7 via the outdoor expansion valve 6. Additionally, the other branching refrigerant pipe 13F communicates and connects with the refrigerant pipe 13B located on a refrigerant downstream side of the check valve 18 via a solenoid valve 22 to be opened during the dehumidifying and located on a refrigerant upstream side of the indoor expansion valve 8.

Consequently, the refrigerant pipe 13F is connected in parallel with a series circuit of the outdoor expansion valve 6, the outdoor heat exchanger 7, and the check valve 18. The refrigerant pipe 13F serves as a circuit which bypasses the outdoor expansion valve 6, the outdoor heat exchanger 7, and the check valve 18.

Also, in the air flow passage 3 on an air upstream side of the heat absorber 9, respective suction ports such as an outdoor air suction port and an indoor air suction port are formed (represented by a suction port 25 in FIG. 1), and in the suction port 25, an air inlet changing damper 26 is provided to change the air to be introduced into the air flow passage 3 to indoor air which is air of the vehicle interior (indoor air circulation) and outdoor air which is air outside the vehicle interior (outdoor air introduction). Further, an indoor blower (a blower fan) 27 to supply the introduced indoor or outdoor air to the air flow passage 3 is provided on an air downstream side of the air inlet changing damper 26.

Further, in FIG. 1, 23 denotes a heater core as an auxiliary heating device. In the embodiment, the heater core 23 is provided in the air flow passage 3 serving as an air upstream side of the radiator 4 to the flow of the air in the air flow passage 3. Then, the heater core 23 is configured so as to be capable of performing heating and heating assistance in the vehicle interior by circulating a heat medium heated as described later in the heater core 23.

Additionally, in the air flow passage 3 on an air upstream side of the radiator 4, there is provided an air mix damper 28 to adjust a ratio at which the air in the air flow passage 3 (the indoor or outdoor air) flowing into the air flow passage 3 and passed through the heat absorber 9 is to be passed through the heater core 23 and the radiator 4. Furthermore, in the air flow passage 3 on an air downstream side of the radiator 4, there is formed each air outlet (represented by an air outlet 29 in FIG. 1) of FOOT (foot), VENT (vent) or DEF (defroster), and in the air outlet 29, an air outlet changing damper 31 is provided to execute changing control of blowing of the air from each air outlet mentioned above.

In addition, the vehicle air conditioner 1 is provided with a temperature adjustment device 61 as the temperature adjustment device of the vehicle-mounted heat-generating equipment of the present invention for circulating the heat medium in the battery 55 and the motor 65 for running and thereby adjusting the temperatures of the battery 55 and the motor 65 for running. That is, in the embodiment, the battery 55 and the motor 65 for running serve as heat generating equipment (vehicle-mounted heat-generating equipment in the present invention) mounted on the vehicle.

Further, the battery 55 generates heat by charging and discharging, and the motor 65 for running is also energized (operated) to generate heat. However, the heating temperature of the battery 55 is generally about +40° C., while that of the motor 65 for running rises even to +70° C. higher than that of the battery 55. Therefore, in the present invention, the battery 55 serves as low heat-generating equipment, and the motor 65 for running serves as high heat-generating equipment.

Incidentally, the high heat-generating equipment in the present invention is not limited to the electric motor itself of the motor 65 for running, but bears the concept of including even electric devices such as an inverter circuit for driving the electric motor itself. Further, it is needless to say that as the high heat-generating equipment, a piece of equipment mounted on the vehicle other than the motor 65 for running and having a heating temperature higher than that of the battery 55 can be applied.

The temperature adjustment device 61 of this embodiment is comprised of a heat medium circulation circuit 60 for circulating a heat medium in the battery 55 and the motor 65 for running. The heat medium circulation circuit 60 includes a first circulation pump 62 and a second circulation pump 63 as circulation devices, a refrigerant-heat medium heat exchanger 64 as a cooling unit, an air-heat medium heat exchanger 67, a heat medium heating heater 66 as a heating unit comprised of an electric heater such as a PTC heater, a first three-way valve 81 that functions as a first flow passage changing device and a fourth flow passage changing device, a second three-way valve 82 as a second flow passage changing device, a third three-way valve 83 as a third flow passage changing device, a fourth three-way valve 84 that functions as the first flow passage changing device and a fourth flow passage changing device in the same manner, and a fifth three-way valve 87 as a fifth flow passage changing device. Those, the battery 55, and the motor 65 for running are connected by a heat medium pipe 68.

In the case of the embodiment, a heat medium pipe 68A is connected to the discharge side of the first circulation pump 62, and the heat medium pipe 68A is connected to the inlet of the heat medium heating heater 66. A heat medium pipe 68B is connected to the outlet of the heat medium heating heater 66, and the heat medium pipe 68B is connected to the inlet of the fifth three-way valve 87. One outlet of the fifth three-way valve 87 is connected to a heat medium pipe 68C, and the heat medium pipe 68C is connected to the inlet of the battery 55. Then, the outlet of the battery 55 is connected to a heat medium pipe 68D, and the heat medium pipe 68D is connected to the inlet of the first three-way valve 81.

One outlet of the first three-way valve 81 is connected to a heat medium pipe 68E, and this heat medium pipe 68E is connected to the inlet of the motor 65 for running. The outlet of the motor 65 for running is connected to a heat medium pipe 68F, and this heat medium pipe 68F is connected to the inlet of the second three-way valve 82. One outlet of the second three-way valve 82 is connected to a heat medium pipe 68G, and this heat medium pipe 68G is connected to the inlet of the heat medium flow passage 64A of the refrigerant-heat medium heat exchanger 64. Then, a heat medium pipe 68H is connected to the outlet of the heat medium flow passage 64A, and this heat medium pipe 68H is connected to the inlet of the third three-way valve 83.

The other outlet of the first three-way valve 81 is connected to a heat medium pipe 68J, and this heat medium pipe 68J is connected to the inlet of the fourth three-way valve 84. One outlet of the fourth three-way valve 84 is connected to a first bypass passage (heat medium pipe) 68K, and this first bypass passage 68K is communicated and connected with the heat medium pipe 68G. Consequently, the first bypass passage 68K bypasses the motor 65 for running.

One outlet of the third three-way valve 83 is connected to a heat medium pipe 68L, and this heat medium pipe 68L is connected to the suction side of the first circulation pump 62. The other outlet of the fourth three-way valve 84 is connected to a third bypass passage (heat medium pipe) 68M, and this third bypass passage 68M is connected to the heat medium pipe 68L. Thus, the third bypass passage 68M bypasses the first bypass passage 68K and the refrigerant-heat medium heat exchanger 64.

The other outlet of the second three-way valve 82 is connected to a heat medium pipe 68N, and this heat medium pipe 68N is connected to the inlet of the air-heat medium heat exchanger 67. The outlet of the air-heat medium heat exchanger 67 is connected to a heat medium pipe 68P, and this heat medium pipe 68P is connected to the suction side of the second circulation pump 63. A heat medium pipe 68T is connected to the discharge side of the second circulation pump 63, and this heat medium pipe 68T is communicated and connected with the heat medium pipe 68E.

The other outlet of the third three-way valve 83 is connected to a second bypass passage (heat medium pipe) 68U, and this second bypass passage 68U is communicated and connected with the heat medium pipe 68P. Consequently, the second bypass passage 68U bypasses the battery 55.

The other outlet of the fifth three-way valve 87 is connected to a fourth bypass passage (heat medium pipe) 68V, and this fourth bypass passage 68V is connected to the inlet of the heater core 23. The fourth bypass passage 68V also bypasses the battery 55. The outlet of the heater core 23 is connected to a heat medium pipe 68W, and this heat medium pipe 68W is communicated and connected with the heat medium pipe 68L.

As the heat medium used in the temperature adjustment device 61, for example, water, a refrigerant like HFO-1234yf, a liquid such as coolant, or a gas such as air can be adopted. Incidentally, in the embodiment, water is used as the heat medium. Further, it is assumed that a jacket structure capable of circulating, for example, a heat medium in a heat exchange relationship with the battery 55 and the motor 65 for running is provided around the battery 55 and the motor 65 for running. Further, the air-heat medium heat exchanger 67 is arranged on the leeward side of the outdoor heat exchanger 7 with respect to the flow (air passage) of the outdoor air (air) ventilated by the outdoor blower 15.

An air conditioning controller 32 (control device) described later has first to sixth circulation modes described below as heat medium circulation modes of the heat medium circulation circuit 60 of the temperature adjustment device 61.

(1) First Circulation Mode

That is, when the first circulation pump 62 is operated at the time that the fifth three-way valve 87 is changed to a state of communicating the inlet and one outlet with each other, the first three-way valve 81 is changed to a state of communicating the inlet and one outlet with each other, the second three-way valve 82 is changed to a state of communicating the inlet and one outlet with each other, and the third three-way valve 83 is changed to a state of communicating the inlet and one outlet with each other, a circulation is performed in which as indicated by sold line arrows in FIG. 1, the heat medium discharged from the first circulation pump 62 flows in order of the heat medium pipe 68A, the heat medium heating heater 66, the heat medium pipe 68B, the fifth three-way valve 87, the heat medium pipe 68C, the battery 55, the heat medium pipe 68D, the first three-way valve 81, the heat medium pipe 68E, the motor 65 for running, the heat medium pipe 68F, the second three-way valve 82, the heat medium pipe 68G, the heat medium flow passage 64A of the refrigerant-heat medium heat exchanger 64, the heat medium pipe 68B, the third three-way valve 83, and the heat medium pipe 68L and is sucked into the first circulation pump 62. This refers to the first circulation mode.

In this first circulation mode, as will be described later, the heat medium heat-absorbed and cooled by the refrigerant in the heat medium flow passage 64A of the refrigerant-heat medium heat exchanger 64 is circulated to the battery 55 and the motor 65 for running and performs heat exchange with these battery 55 and motor 65 for running to recover the waste heat from the battery 55 and the motor 65 for running and cool the battery 55 and the motor 65 for running themselves. Further, in this first circulation mode, the heat medium cooled in the heat medium flow passage 64A of the refrigerant-heat medium heat exchanger 64 (cooling unit) passes through the battery 55 (low heat-generating equipment), and then flows to the motor 65 for running (high heat-generating equipment). Therefore, even when the single refrigerant-heat medium heat exchanger 64 (cooling unit) is used, the battery 55 (low heat-generating equipment) is prevented from being heated by the motor 65 for running (high heat-generating equipment) through the heat medium.

(2) Second Circulation Mode

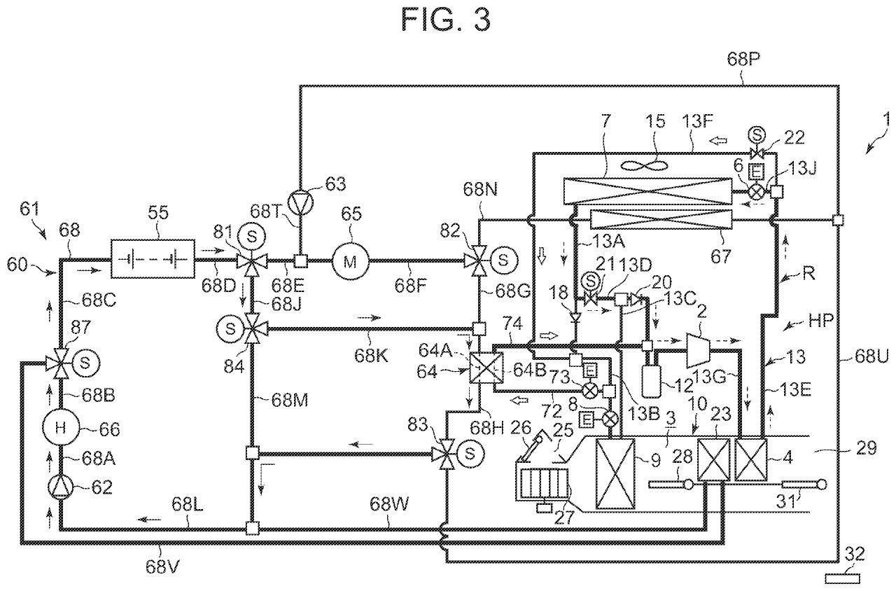

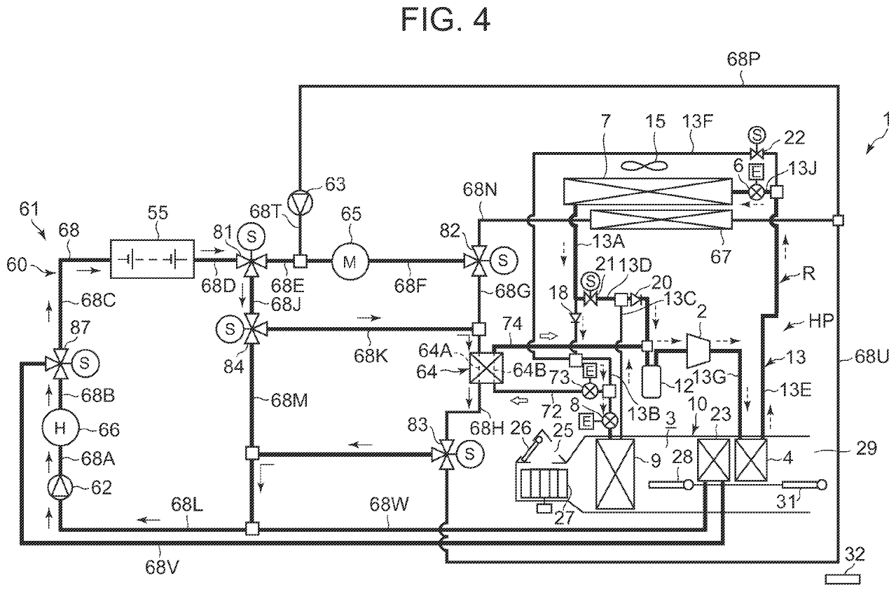

Further, when the first circulation pump 62 is operated at the time that the fifth three-way valve 87 is changed to a state of communicating the inlet and one outlet with each other, the first three-way valve 81 is changed to a state of communicating the inlet and the other outlet with each other, the fourth three-way valve 84 is changed to a state of communicating the inlet and one outlet with each other, and the third three-way valve 83 is changed to a state of communicating the inlet and one outlet with each other, a circulation is performed in which as indicated by sold line arrows in FIGS. 3 and 4, the heat medium discharged from the first circulation pump 62 flows in order of the heat medium pipe 68A, the heat medium heating heater 66, the heat medium pipe 68B, the fifth three-way valve 87, the heat medium pipe 68C, the battery 55, the heat medium pipe 68D, the first three-way valve 81, the heat medium pipe 68J, the fourth three-way valve 84, the first bypass passage 68K, the heat medium pipe 68G, the heat medium flow passage 64A of the refrigerant-heat medium heat exchanger 64, the heat medium pipe 68H, the third three-way valve 83, and the heat medium pipe 68L and is sucked into the first circulation pump 62. This refers to the second circulation mode.

In this second circulation mode, as will be described later, the heat medium heat-absorbed and cooled by the refrigerant in the heat medium flow passage 64A of the refrigerant-heat medium heat exchanger 64 is circulated only to the battery 55 and uncirculated to the motor 65 for running. Then, the heat medium exchanges heat with the battery 55 to recover the waste heat from the battery 55 and to cool the battery 55 itself. Further, as will be described later, if this second circulation mode is executed in the heating operation to allow the heat medium heating heater 66 to generate heat, the heat from the heat medium heating heater 66 is also recovered into the refrigerant by the refrigerant-heat medium heat exchanger 64, and can be transferred to the radiator 4.

(3) Third Circulation Mode

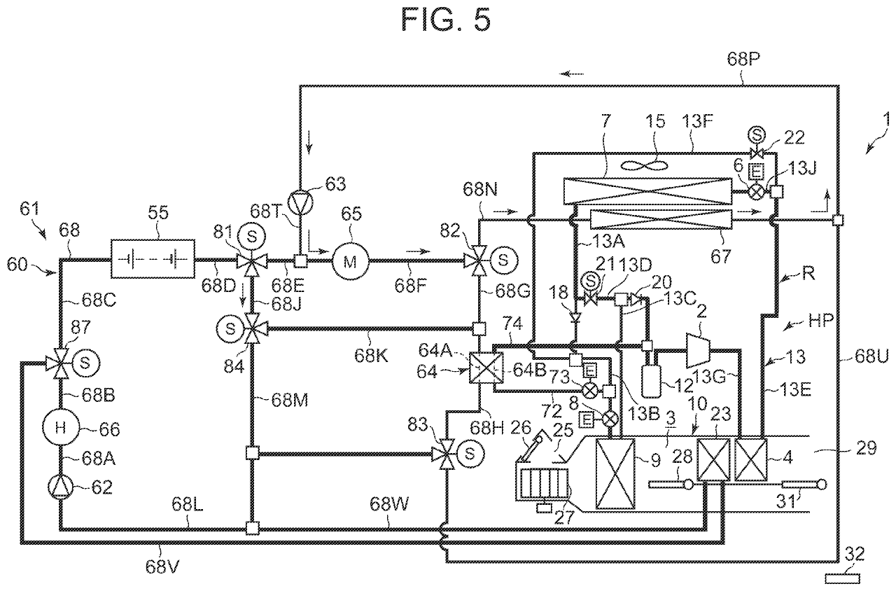

Further, when the second circulation pump 63 is operated at the time that the second three-way valve 82 is changed to a state of communicating the inlet and the other outlet with each other, a circulation is performed in which as indicated by solid line arrows in FIG. 5, the heat medium discharged from the second circulation pump 63 flows in order of the heat medium pipe 68T, the heat medium pipe 68E, the motor 65 for running, the heat medium pipe 68F, the second three-way valve 82, the heat medium pipe 68N, the air-heat medium heat exchanger 67, and the heat medium pipe 68P and is sucked into the second circulation pump 63. This refers to the third circulation mode.

In this third circulation mode, since the heat medium is circulated between the motor 65 for running and the air-heat medium heat exchanger 67, the heat medium cooled by the outdoor air in the air-heat medium heat exchanger 67 is circulated to the motor 65 for running, and the motor 65 for running can be cooled by the outdoor air.

(4) Fourth Circulation Mode

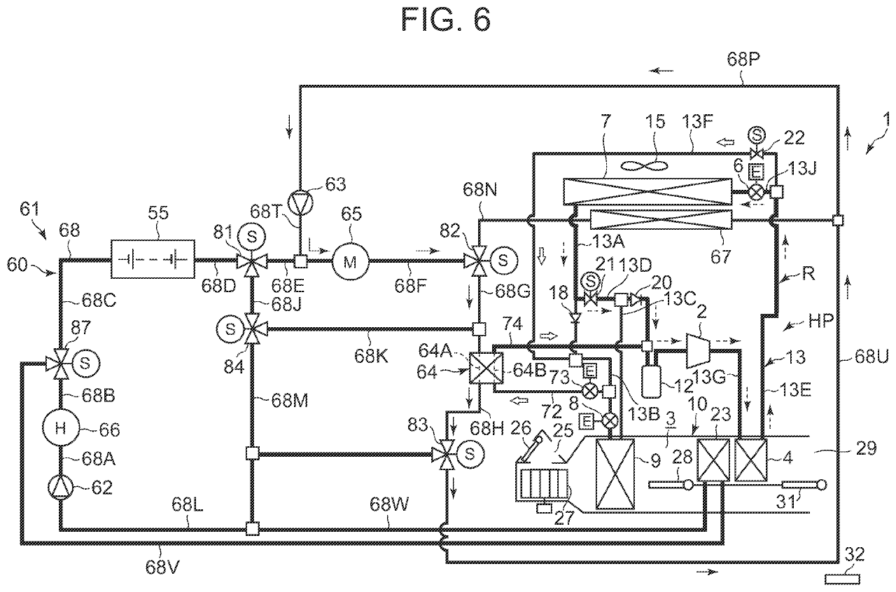

Further, when the second circulation pump 63 is operated at the time that the second three-way valve 82 is changed to a state of communicating the inlet and one outlet with each other and the third three-way valve 83 is changed to a state of communicating the inlet and the other outlet with each other, a circulation is performed in which as indicated by solid line arrows in FIG. 6, the heat medium discharged from the second circulation pump 63 flows in order of the heat medium pipe 68T, the heat medium pipe 68E, the motor 65 for running, the heat medium pipe 68F, the second three-way valve 82, the heat medium pipe 68G, the heat medium flow passage 64A of the refrigerant-heat medium heat exchanger 64, the heat medium pipe 68H, the third three-way valve 83, the second bypass passage 68U, and the heat medium pipe 68P and is sucked into the second circulation pump 63. This refers to the fourth circulation mode.

In this fourth circulation mode, as will be described later, the heat medium heat-absorbed and cooled by the refrigerant in the heat medium flow passage 64A of the refrigerant-heat medium heat exchanger 64 is circulated only to the motor 65 for running and uncirculated to the battery 55. Then, the heat medium exchanges heat with the motor 65 for running to recover the waste heat from the motor 65 for running and cool the motor 65 for running itself.

(5) Fifth Circulation Mode

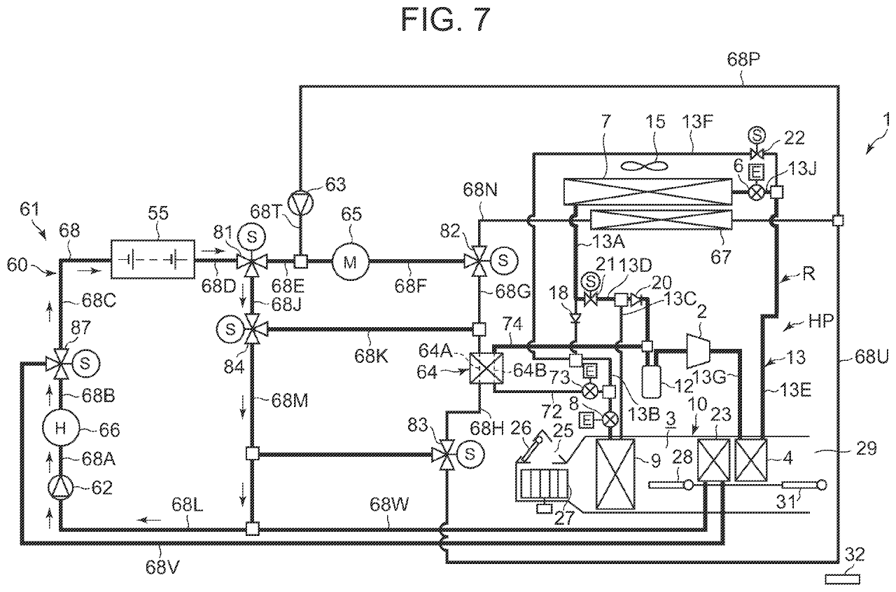

Further, when the first circulation pump 62 is operated at the time that the fifth three-way valve 87 is changed to a state of communicating the inlet and one outlet with each other, the first three-way valve 81 is changed to a state of communicating the inlet and the other outlet with each other, and the fourth three-way valve 84 is changed to a state of communicating the inlet and the other outlet with each other, a circulation is performed in which as indicated by sold line arrows in FIG. 7, the heat medium discharged from the first circulation pump 62 flows in order of the heat medium pipe 68A, the heat medium heating heater 66, the heat medium pipe 68B, the fifth three-way valve 87, the heat medium pipe 68C, the battery 55, the heat medium pipe 68D, the first three-way valve 81, the heat medium pipe 68J, the fourth three-way valve 84, the third bypass passage 68M, and the heat medium pipe 68L and is sucked into the first circulation pump 62. This refers to the fifth circulation mode.

In this fifth circulation mode, the heat medium is circulated between the battery 55 and the heat medium heating heater 66. Therefore, the battery 55 can be heated with the heat medium heating heater 66 by allowing the heat medium heating heater 66 to generate heat

(6) Second Circulation Mode+Third Circulation Mode

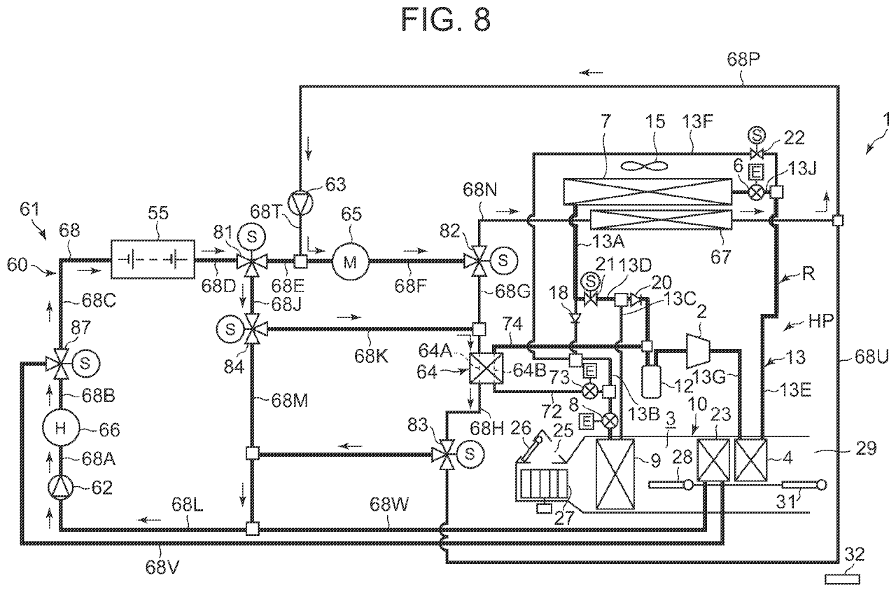

Further, when the first circulation pump 62 and the second circulation pump 63 are operated at the time that the fifth three-way valve 87 is changed to a state of communicating the inlet and one outlet with each other, the first three-way valve 81 is changed to a state of communicating the inlet and the other outlet with each other, the fourth three-way valve 84 is changed to a state of communicating the inlet and one outlet with each other, and the second three-way valve 82 is changed to a state of communicating the inlet and the other outlet with each other, a circulation is performed in which as indicated by sold line arrows in FIG. 8, the heat medium discharged from the first circulation pump 62 flows in order of the heat medium pipe 68A, the heat medium heating heater 66, the heat medium pipe 68B, the fifth three-way valve 87, the heat medium pipe 68C, the battery 55, the heat medium pipe 68D, the first three-way valve 81, the heat medium pipe 68J, the fourth three-way valve 84, the first bypass passage 68K, the heat medium pipe 68G, the heat medium flow passage 64A of the refrigerant-heat medium heat exchanger 64, the heat medium pipe 68H, and the heat medium pipe 68L and is sucked into the first circulation pump 62, and the heat medium discharged from the second circulation pump 63 flows in order of the heat medium pipe 68T, the heat medium pipe 68E, the motor 65 for running, the heat medium pipe 68F, the second three-way valve 82, the heat medium pipe 68N, the air-heat medium heat exchanger 67, and the heat medium pipe 68P and is sucked into the second circulation pump 63. This refers to the circulation mode of the second circulation mode+the third circulation mode.

In the circulation mode of the second circulation mode+the third circulation mode, the heat medium cooled by the refrigerant in the heat medium flow passage 64A of the refrigerant-heat medium heat exchanger 64 is circulated to the battery 55. Therefore, since the battery 55 is cooled by the refrigerant, and the heat medium is circulated between the motor 65 for running and the air-heat medium heat exchanger 67, the heat medium cooled by the outdoor air in the air-heat medium heat exchanger 67 is circulated to the motor 65 for running, and the motor 65 for running is cooled by the outdoor air.

(7) Sixth Circulation Mode

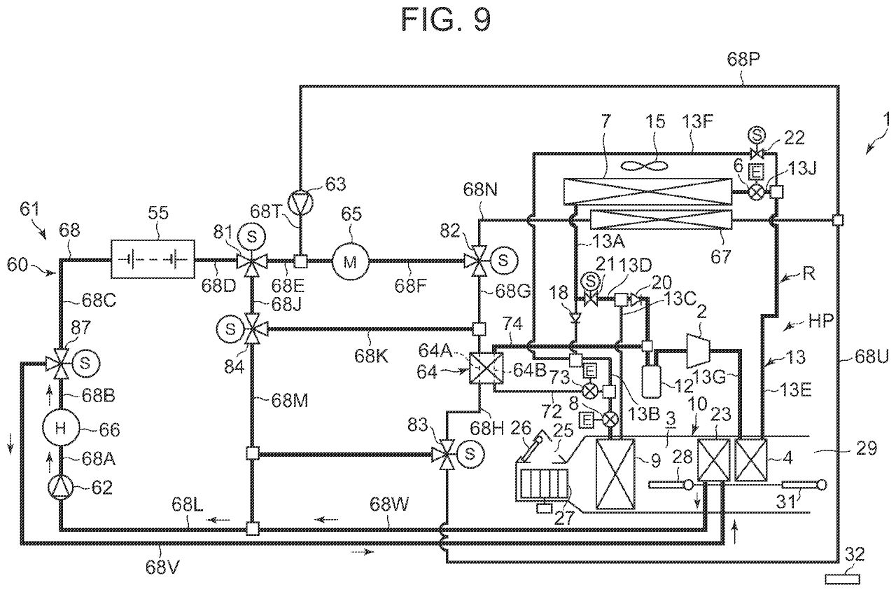

Further, when the first circulation pump 62 is operated at the time that the fifth three-way valve 87 is changed to a state of communicating the inlet and the other outlet with each other, a circulation is performed in which as indicated by sold line arrows in FIG. 9, the heat medium discharged from the first circulation pump 62 flows in order of the heat medium pipe 68A, the heat medium heating heater 66, the heat medium pipe 68B, the fifth three-way valve 87, the fourth bypass passage 68V, the heater core 23, the heat medium pipe 68W, and the heat medium pipe 68L and is sucked into the first circulation pump 62. This refers to the sixth circulation mode.

In this sixth circulation mode, since the heat medium is circulated between the heater core 23 and the heat medium heating heater 66, the heat medium heating heater 66 is caused to generate heat, thereby making it possible to let the heat medium heated by the heat medium heating heater 66 radiate heat in the heater core 23 and heat the vehicle interior. Incidentally, the changing between the first circulation mode and the sixth circulation mode described above will be described in detail later.

On the other hand, one end of a branch pipe 72 as a branch circuit is connected to the outlet of the refrigerant pipe 13F of the refrigerant circuit R, i e., the refrigerant pipe 13B located on the refrigerant downstream side of a connection portion between the refrigerant pipe 13F and the refrigerant pipe 13B and on the refrigerant upstream side of the indoor expansion valve 8. This branch pipe 72 is provided with an auxiliary expansion valve 73 comprised of an electric valve. The auxiliary expansion valve 73 decompresses and expands the refrigerant flowing into a refrigerant flow passage 64B to be described later, of the refrigerant-heat medium heat exchanger 64 and is capable of full closing as well.

Then, the other end of the branch pipe 72 is connected to the refrigerant flow passage 64B of the refrigerant-heat medium heat exchanger 64. One end of a refrigerant pipe 74 is connected to the outlet of the refrigerant flow passage 64B. The other end of the refrigerant pipe 74 is connected to the refrigerant pipe 13C located on the refrigerant downstream side of the check valve 20 and in front of the accumulator 12 (refrigerant upstream side). Then, the auxiliary expansion valve 73 and the like of these also constitute a pan of the refrigerant circuit R of the heat pump device HP, and at the same time, constitute even a part of the temperature adjustment device 61.

When the auxiliary expansion valve 73 is open, the refrigerant (part or all of the refrigerant) discharged from the refrigerant pipe 13F and the outdoor heat exchanger 7 flows into the branch pipe 72 and is decompressed by the auxiliary expansion valve 73, and then the refrigerant flows into the refrigerant flow passage 64B of the refrigerant-heat medium heat exchanger 64 and evaporates there. The refrigerant absorbs heat from the heat medium flowing through the heat medium flow passage 64A in the process of flowing through the refrigerant flow passage 64B, and then is sucked into the compressor 2 via the accumulator 12.

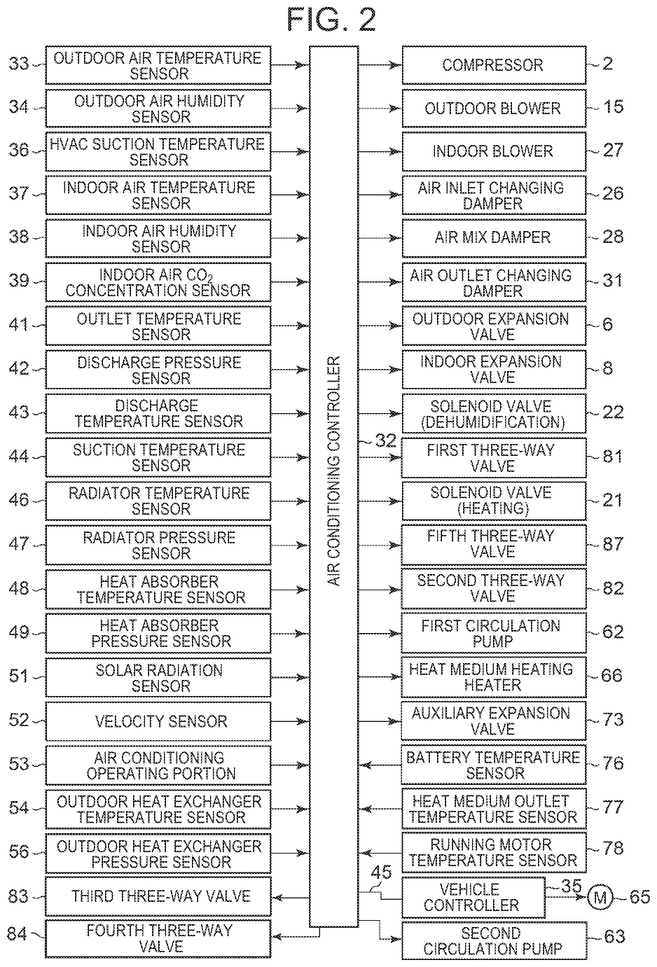

Next, in FIG. 2, 32 is an air conditioning controller as a control device which performs control of the vehicle air conditioner 1. The air conditioning controller 32 is configured to be connected via a vehicle communication bus 45 to a vehicle controller 35 (ECU) which performs control of the entire vehicle including drive control of the motor 65 for running and charging/discharging control of the battery 55 and to perform transmission and reception of information. Both of these air conditioning controller 32 and vehicle controller 35 (ECU) are constituted of a microcomputer that is an example of a computer including a processor.

An input of the air conditioning controller 32 (control device) is connected with respective outputs of an outdoor air temperature sensor 33 which detects an outdoor air temperature (Tam) of the vehicle, an outdoor air humidity sensor 34 which detects an outdoor air humidity, an HVAC suction temperature sensor 36 which detects a temperature of the air to be sucked from the suction port 25 to the air flow passage 3, an indoor air temperature sensor 37 which detects a temperature of the air (indoor air) of the vehicle interior, an indoor air humidity sensor 38 which detects a humidity of the air of the vehicle interior, an indoor air CO₂ concentration sensor 39 which detects a carbon dioxide concentration of the vehicle interior, an outlet temperature sensor 41 which detects a temperature of the air to be blown out from the outlet 29 to the vehicle interior, a discharge pressure sensor 42 which detects a pressure (discharge pressure Pd) of the refrigerant discharged from the compressor 2, a discharge temperature sensor 43 which detects a temperature of the refrigerant discharged from the compressor 2, a suction temperature sensor 44 which detects a temperature of the refrigerant to be sucked into the compressor 2, a radiator temperature sensor 46 which detects a temperature of the radiator 4 (the temperature of the air passed through the radiator 4 or the temperature of the radiator 4 itself: a radiator temperature TCI), a radiator pressure sensor 47 which detects a refrigerant pressure of the radiator 4 (the pressure of the refrigerant in the radiator 4 or immediately after the refrigerant flows out from the radiator 4: a radiator pressure PCI), a heat absorber temperature sensor 48 which detects a temperature of the heat absorber 9 (the temperature of the air passed through the heat absorber 9 or the temperature of the heat absorber 9 itself: a heat absorber temperature Te), a heat absorber pressure sensor 49 which detects a refrigerant pressure of the heat absorber 9 (the pressure of the refrigerant in the heat absorber 9 or immediately after the refrigerant flows out from the heat absorber 9), a solar radiation sensor 51 of, e.g., a photo sensor system to detect a solar radiation amount into the vehicle interior, a velocity sensor 52 to detect a moving speed (a velocity) of the vehicle, an air conditioning operating portion 53 to set the changing of a predetermined temperature or an air conditioning operation, an outdoor heat exchanger temperature sensor 54 which detects a temperature of the outdoor heat exchanger 7 (the temperature of the refrigerant immediately after the refrigerant flows out from the outdoor heat exchanger 7, or the temperature of the outdoor heat exchanger 7 itself: an outdoor heat exchanger temperature TXO. When the outdoor heat exchanger 7 functions as an evaporator, the outdoor heat exchanger temperature TXO becomes an evaporation temperature of the refrigerant in the outdoor heat exchanger 7), and an outdoor heat exchanger pressure sensor 56 which detects a refrigerant pressure of the outdoor heat exchanger 7 (the pressure of the refrigerant in the outdoor heat exchanger 7 or immediately after the refrigerant flows out from the outdoor heat exchanger 7).

Further, the input of the air conditioning controller 32 is further connected also with respective outputs of a battery temperature sensor 76 which detects a temperature of the battery 55 (a temperature of the battery 55 itself, or a temperature of the heat medium flowing out from the battery 55, or a temperature of the heat medium flowing into the battery 55: a battery temperature Tb), a heat medium outlet temperature sensor 77 which detects a temperature of the heat medium flowing out from the heat medium flow passage 64A of the refrigerant-heat medium heat exchanger 64, and a running motor temperature sensor 78 which detects a temperature of the motor 65 for running (a temperature of the motor 65 for running itself, or a temperature of the heat medium flowing out from the motor 65 for running, or a temperature of the heat medium flowing into the motor 65 for running: a running motor temperature Tm).

On the other hand, an output of the air conditioning controller 32 is connected with the compressor 2, the outdoor blower 15, the indoor blower (the blower fan) 27, the air inlet changing damper 26, the air mix damper 28, the air outlet changing damper 31, the outdoor expansion valve 6, the indoor expansion valve 8, the respective solenoid valves of the solenoid valve 22 (dehumidification) and the solenoid valve 21 (heating), the first and second circulation pumps 62 and 63, the auxiliary expansion valve 73, and the first to fifth three-way valves 81 to 84 and 87. Then, the air conditioning controller 32 controls these components on the basis of the outputs of the respective sensors and the setting input by the air conditioning operating portion 53, and information from the vehicle controller 35.

Next, the operation of the vehicle air conditioner 1 of the embodiment will be described in the above configuration. In the embodiment, the air conditioning controller 32 (control device) changes and executes the respective air conditioning operations of the heating operation, the dehumidifying and heating operation, the dehumidifying and cooling operation, and the cooling operation and adjusts the temperatures of the battery 55 (low heat-generating equipment) and the motor 65 for running (high heat-generating equipment). Description will initially be made as to each air conditioning operation of the heat pump device HP of the vehicle air conditioner 1.

(8) Heating Operation

Description will first be made as to the heating operation with reference to FIGS. 1, 3, and 6. FIGS. 1, 3, and 6 show the flow (broken line arrows) of the refrigerant of the refrigerant circuit R in the heating operation. When the heating operation is selected by the air conditioning controller 32 (an automatic mode) or a manual operation to the air conditioning operating portion 53 (a manual mode) in winter or the like, the air conditioning controller 32 opens the solenoid valve 21 (for the heating) and fully closes the indoor expansion valve 8. Further, the air conditioning controller closes the solenoid valve 22 (for the dehumidification).

Then, the air conditioning controller operates the compressor 2 and the respective blowers 15 and 27, and the air mix damper 28 has a state of adjusting a ratio at which the air blown out from the indoor blower 27 is to be passed through the heater core 23 and the radiator 4. In consequence, a high-temperature high-pressure gas refrigerant discharged from the compressor 2 flows into the radiator 4. The air in the air flow passage 3 passes through the radiator 4, and hence the air in the air flow passage 3 is heated by the high-temperature refrigerant in the radiator 4. On the other hand, the refrigerant in the radiator 4 has the heat taken by the air and is cooled to condense and liquefy.

The refrigerant liquefied in the radiator 4 flows out from the radiator 4 and then flows through the refrigerant pipes 13E and 13J to reach the outdoor expansion valve 6. The refrigerant flowing into the outdoor expansion valve 6 is decompressed therein, and then flows into the outdoor heat exchanger 7. The refrigerant flowing into the outdoor heat exchanger 7 evaporates, and the heat is pumped up from the outdoor air passed by running or the outdoor blower 15 (heat absorption). Then, the low-temperature refrigerant flowing out from the outdoor heat exchanger 7 reaches the refrigerant pipe 13C through the refrigerant pipe 13A and the refrigerant pipe 13D, and the solenoid valve 21, and flows into the accumulator 12 via the check valve 20 in the refrigerant pipe 13C to perform gas-liquid separation therein, and the gas refrigerant is then sucked into the compressor 2, thereby repeating this circulation. The air heated in the radiator 4 is blown out from the outlet 29, thereby performing the heating of the vehicle interior.

The air conditioning controller 32 calculates a target radiator pressure PCO (a target value of the pressure PCI of the radiator 4) from a target heater temperature TCO (a target value of a temperature of the air on the leeward side of the radiator 4) calculated from an after-mentioned target outlet temperature TAO, and controls the number of revolutions of the compressor 2 on the basis of the target radiator pressure PCO and the refrigerant pressure of the radiator 4 which is detected by the radiator pressure sensor 47 (the radiator pressure PCI that is a high pressure of the refrigerant circuit R). Further, the air conditioning controller controls a valve position of the outdoor expansion valve 6 on the basis of the temperature (the radiator temperature TCI) of the radiator 4 which is detected by the radiator temperature sensor 46 and the radiator pressure PCI detected by the radiator pressure sensor 47, and controls a subcool degree of the refrigerant in an outlet of the radiator 4. The target heater temperature TCO is basically TCO=TAO, but a predetermined limit of controlling is provided. Further, when the heating capability by the radiator 4 runs short, the heat medium heating heater 66 is energized to generate heat thereby to complement the heating capability as will be described later.

Further, in this heating operation, the air conditioning controller 32 opens the solenoid valve 22 and also opens the auxiliary expansion valve 73 to put its valve position in a controlled state. Thus, a part of the refrigerant flowing out from the radiator 4 is distributed on the refrigerant upstream side of the outdoor expansion valve 6 and reaches the refrigerant upstream side of the indoor expansion valve 8 through the refrigerant pipe 13F as indicated by void arrows in FIGS. 1, 3, and 6. Next, the refrigerant flows into the branch pipe 72 and is decompressed by the auxiliary expansion valve 73, and then flows into the refrigerant flow passage 64B of the refrigerant-heat medium heat exchanger 64 through the branch pipe 72 to evaporate. At this time, a heat absorbing operation is exerted. A circulation is repeated in which the refrigerant evaporated in this refrigerant flow passage 64B flows through the refrigerant pipe 74, the refrigerant pipe 13C, and the accumulator 12 successively and is sucked into the compressor 2.

(9) Dehumidifying and Heating Operation

Next, in the dehumidifying and heating operation, the air conditioning controller 32 opens the solenoid valve 22 in the above state of the heating operation and opens the indoor expansion valve 8 to set the refrigerant to a state of decompressing and expanding it. Consequently, a part of the condensed refrigerant flowing into the refrigerant pipe 13E through the radiator 4 is distributed, the distributed refrigerant flows through the solenoid valve 22 into the refrigerant pipe 13F and flows from the refrigerant pipe 13B into the indoor expansion valve 8, and the residual refrigerant flows through the outdoor expansion valve 6. That is, the distributed part of the refrigerant is decompressed in the indoor expansion valve 8, and then flows into the heat absorber 9 to evaporate.

The air conditioning controller 32 controls a valve position of the indoor expansion valve 8 to maintain a superheat degree (SH) of the refrigerant in an outlet of the heat absorber 9 at a predetermined value, but water in the air blown out from the indoor blower 27 coagulates to adhere to the heat absorber 9 by a heat absorbing operation of the refrigerant which occurs in the heat absorber 9 at this time, and hence, the air is cooled and dehumidified. The distributed residual refrigerant flowing into the refrigerant pipe 13J is decompressed in the outdoor expansion valve 6, and then evaporates in the outdoor heat exchanger 7.

The refrigerant evaporated in the heat absorber 9 flows out to the refrigerant pipe 13C to join the refrigerant (the refrigerant from the outdoor heat exchanger 7) from the refrigerant pipe 13D, and then flows through the check valve 20 and the accumulator 12 to be sucked into the compressor 2, thereby repeating this circulation. The air dehumidified in the heat absorber 9 is reheated in the process of passing the radiator 4, thereby performing the dehumidifying and heating of the vehicle interior.

The air conditioning controller 32 controls the number of revolutions of the compressor 2 on the basis of the target radiator pressure PCO calculated from the target heater temperature TCO and the radiator pressure PCI detected by the radiator pressure sensor 47 (the high pressure of the refrigerant circuit R), and controls the valve position of the outdoor expansion valve 6 on the basis of the temperature (the heat absorber temperature Te) of the heat absorber 9 which is detected by the heat absorber temperature sensor 48.

(10) Dehumidifying and Cooling Operation

Next, in the dehumidifying and cooling operation, the air conditioning controller 32 opens the indoor expansion valve 8 to put the refrigerant in a decompressed and expanded state and closes the solenoid valve 21 and the solenoid valve 22. Then, the air conditioning controller operates the compressor 2 and the respective blowers 15 and 27, and the air mix damper 28 has a state of adjusting a ratio at which the air blown out from the indoor blower 27 is to be passed through the heater core 23 and the radiator 4. Consequently, a high-temperature high-pressure gas refrigerant discharged from the compressor 2 flows into the radiator 4. The air in the air flow passage 3 passes through the radiator 4, and hence the air in the air flow passage 3 is heated by the high-temperature refrigerant in the radiator 4. On the other hand, the refrigerant in the radiator 4 has the heat taken by the air and is cooled to condense and liquefy.

The refrigerant flowing out from the radiator 4 flows through the refrigerant pipe 13E to reach the outdoor expansion valve 6, and flows through the outdoor expansion valve 6 controlled to slightly open, to flow into the outdoor heat exchanger 7. The refrigerant flowing into the outdoor heat exchanger 7 is cooled by the running therein or the outdoor air passed through the outdoor blower 15 to condense. The refrigerant flowing out from the outdoor heat exchanger 7 flows through the refrigerant pipe 13A and the check valve 18 to enter the refrigerant pipe 13B and reach the indoor expansion valve 8. The refrigerant is decompressed in the indoor expansion valve 8 and then flows into the heat absorber 9 to evaporate. The water in the air blown out from the indoor blower 27 coagulates to adhere to the heat absorber 9 by the heat absorbing operation at this time, and hence, the air is cooled and dehumidified.

The refrigerant evaporated in the heat absorber 9 flows through the refrigerant pipe 13C and the check valve 20 to reach the accumulator 12, and flows through the accumulator 12 to be sucked into the compressor 2, thereby repeating this circulation. The air cooled and dehumidified in the heat absorber 9 is reheated in the process of passing the radiator 4 (reheating: a radiation capability is lower than that during the heating), thereby performing the dehumidifying and cooling of the vehicle interior.

The air conditioning controller 32 controls, based on the temperature (the heat absorber temperature Te) of the heat absorber 9 which is detected by the heat absorber temperature sensor 48, and a target heat absorber temperature TEO being its target value, the number of revolutions of the compressor 2 to set the heat absorber temperature Te to the target heat absorber temperature TEO, and controls, based on the radiator pressure PCI (the high pressure of the refrigerant circuit R) detected by the radiator pressure sensor 47 and the target radiator pressure PCO (the target value of the radiator pressure PCI) calculated from the target heater temperature TCO, the valve position of the outdoor expansion valve 6 to set the radiator pressure PCI to the target radiator pressure PCO, thereby obtaining a required amount of reheat by the radiator 4.

(11) Cooling Operation

Next, description will be made as to the cooling operation with reference to FIG. 4. In the cooling operation executed in summer or the like, the air conditioning controller 32 fully opens the outdoor expansion valve 6 in the above state of dehumidifying and cooling operation. It is to be noted that the air mix damper 28 has a state of adjusting a ratio at which the air is to be passed through the heater core 23 and the radiator 4.

Consequently, the high-temperature high-pressure gas refrigerant discharged from the compressor 2 flows into the radiator 4 as indicated by broken line arrows in FIG. 4. The air in the air flow passage 3 is passed through the radiator 4 but its ratio becomes small (because of only reheat during the cooling). The refrigerant therefore only passes the radiator, and the refrigerant flowing out from the radiator 4 flows through the refrigerant pipe 13E to reach the outdoor expansion valve 6. At this time, the outdoor expansion valve 6 is fully opened, and hence, the refrigerant passes the refrigerant pipe 13J through the outdoor expansion valve 6 and flows into the outdoor heat exchanger 7 as it is, in which the refrigerant is cooled by the running therein or the outdoor air to pass through the outdoor blower 15, to condense and liquefy.

The refrigerant flowing out from the outdoor heat exchanger 7 flows through the refrigerant pipe 13A and the check valve 18 to enter the refrigerant pipe 13B and reach the indoor expansion valve 8. The refrigerant is decompressed in the indoor expansion valve 8 and then flows into the heat absorber 9 to evaporate. The water in the air blown out from the indoor blower 27 coagulates to adhere to the heat absorber 9 by the heat absorbing operation at this time, and hence, the air is cooled.

The refrigerant evaporated in the heat absorber 9 flows through the refrigerant pipe 13C and the check valve 20 to reach the accumulator 12, and flows therethrough to be sucked into the compressor 2, thereby repeating this circulation. The air cooled and dehumidified in the heat absorber 9 is blown out from the outlet 29 to the vehicle interior, thereby performing the cooling of the vehicle interior. In this cooling operation, the air conditioning controller 32 controls the number of revolutions of the compressor 2 on the basis of the temperature (the heat absorber temperature Te) of the heat absorber 9 which is detected by the heat absorber temperature sensor 48.

Further, in this cooling operation, the air conditioning controller 32 opens the auxiliary expansion valve 73 to put its valve position in a controlled state. Thus, a part of the refrigerant flowing out from the outdoor heat exchanger 7 is distributed on the refrigerant upstream side of the indoor expansion valve 8 and as indicated by void arrows in FIG. 4 flows into the branch pipe 72 and is decompressed by the auxiliary expansion valve 73, and then flows into the refrigerant flow passage 64B of the refrigerant-heat medium heat exchanger 64 through the branch pipe 72 to evaporate. At this time, a heat absorbing operation is exerted. A circulation is repeated in which the refrigerant evaporated in this refrigerant flow passage 64B flows through the refrigerant pipe 74, the refrigerant pipe 13C, and the accumulator 12 successively and is sucked into the compressor 2.

(12) Changing of Air Conditioning Operation

The air conditioning controller 32 calculates the above-mentioned target outlet temperature TAO from the following equation (I). The target outlet temperature TAO is a target value of the temperature of the air to be blown out from the outlet 29 to the vehicle interior.

TAO=(Tset−Tin)×K+Tbal(f(Tset,SUN,Tam)) (I)

where Tset is a predetermined temperature of the vehicle interior which is set by the air conditioning operating portion 53, Tin is a temperature of the vehicle interior air which is detected by the indoor air temperature sensor 37, K is a coefficient, and Tbal is a balance value calculated from the predetermined temperature Tset, a solar radiation amount SUN detected by the solar radiation sensor 51, and the outdoor air temperature Tam detected by the outdoor air temperature sensor 33. Further, in general, the target outlet temperature TAO is high as the outdoor air temperature Tam becomes low, and the target outlet temperature TAO is lowered as the outdoor air temperature Tam rises.

Then, the air conditioning controller 32 selects any air conditioning operation from the above respective air conditioning operations on the basis of the outdoor air temperature Tam detected by the outdoor air temperature sensor 33 and the target outlet temperature TAO on startup. Further, after the startup, the air conditioning controller selects and changes the above respective air conditioning operations in accordance with changes of environments and setting conditions such as the outdoor air temperature Tam and the target outlet temperature TAO.

(13) Changing Control of Circulation Mode

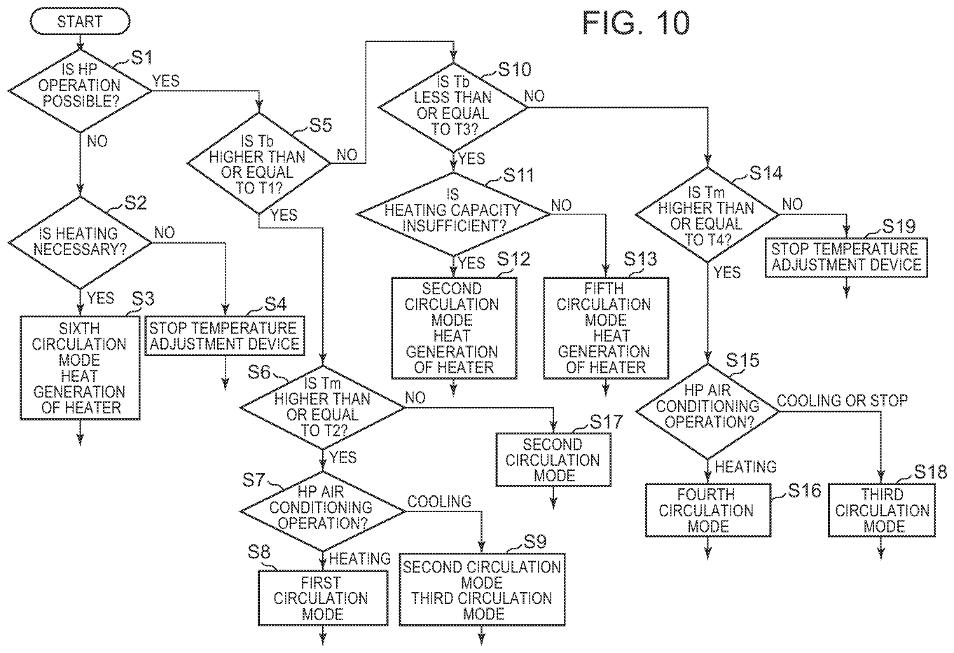

Next, description will be made as to circulation mode changing control of the heat medium in the temperature adjustment device 61 by the air conditioning controller 32 with reference to a flowchart of FIG. 10. The air conditioning controller 32 determines in Step S1 of FIG. 10 whether or not the heat pump device HP can be operated. When the heat pump device HP cannot be operated due to, for example, the occurrence of over-frosting on the outdoor heat exchanger 7, etc., the air conditioning controller 32 proceeds to Step S2 and determines whether or not heating of the vehicle interior is necessary.

In Step S2, for example, when the temperature Tin of the vehicle interior air detected by the indoor air temperature sensor 37 is near the predetermined temperature Tset and heating is not required, the air conditioning controller 32 proceeds to Step S4 to stop the temperature adjustment device 61. On the other hand, when the temperature Tin of the vehicle interior air is lower than the predetermined temperature Tset and heating is required in Step S2, the air conditioning controller proceeds to Step S3 where the heat medium circulation circuit 60 of the temperature adjustment device 61 is set to the sixth circulation mode (FIG. 9), the heat medium heating heater 66 is energized to generate heat, and the first circulation pump 62 is operated. Further, although the compressor 2 is stopped, the indoor blower 27 operates.

Consequently, since the heat medium is circulated between the heater core 23 and the heat medium heating heater 66, the heat medium heated by the heat medium heating heater 66 radiates heat in the heater core 23. The air circulating in the air flow passage 3 by the indoor blower 27 is heated by the heater core 23 and blown out into the vehicle interior, so that the vehicle interior is heated.

Next, when it is possible to operate the heat pump device HP in Step S1, the air conditioning controller 32 proceeds to Step S5 to determine whether or not the battery temperature Tb detected by the battery temperature sensor 76 is higher than or equal to a predetermined value T1. Incidentally, the predetermined value T1 is assumed to be a predetermined high heat generation temperature that requires cooling of the battery 55. When the battery temperature Tb is higher than or equal to the predetermined value T1 in Step S5, the air conditioning controller 32 proceeds to Step S6, and this time determines whether or not the running motor temperature Tm detected by the running motor temperature sensor 78 is higher than or equal to a predetermined value T2. Incidentally, the predetermined value T2 is a relatively high temperature as the heat generation temperature of the motor 65 for running and is taken to be T2>T1.

When the running motor temperature Tm is higher than or equal to the predetermined value T2 in Step S6, the air conditioning controller 32 proceeds to Step S7 to judge the current air conditioning operation of the heat pump device HP. Then, when the current air conditioning operation is the heating operation in Step S7, the air conditioning controller proceeds to Step S8 where the heat medium circulation circuit 60 of the temperature adjustment device 61 is set to the first circulation mode (FIG. 1), the first circulation pump 62 is operated, and the heat medium heating heater 66 is de-energized.

Consequently, the heat medium heat-absorbed and cooled by the refrigerant in the heat medium flow passage 64A of the refrigerant-heat medium heat exchanger 64 is circulated to the battery 55 and the motor 65 for running. The heat medium performs heat exchange with these battery 55 and motor 65 for running to recover the waste heat from the battery 55 and the motor 65 for running and to cool the battery 55 and motor 65 for running themselves. The recovered waste heat is transferred to the radiator 4 by the refrigerant and used for heating the interior of the vehicle. Further, as described above, since the heat medium cooled in the heat medium flow passage 64A of the refrigerant-heat medium heat exchanger 64 (cooling unit) passes through the battery 55 (low heat-generating equipment) and then flows into the motor 65 for running (high heat-generating equipment), the battery 55 (low heat-generating equipment) is not heated by the motor 65 for running (high heat-generating equipment) via the heat medium.

When the air conditioning operation is the cooling operation in Step S7, the air conditioning controller proceeds to Step S9 where the heat medium circulation circuit 60 of the temperature adjustment device 61 is set to the second circulation mode+the third circulation mode (FIG. 8), the first circulation pump 62 and the second circulation pump 63 are operated, and the heat medium heating heater 66 is de-energized. Consequently, the heat medium heat-absorbed and cooled by the refrigerant in the heat medium flow passage 64A of the refrigerant-heat medium heat exchanger 64 is circulated only to the battery 55 by the first circulation pump 62. Then, the heat medium exchanges heat with the battery 55 to cool the battery 55.

Further, since the heat medium is circulated between the motor 65 for running and the air-heat medium heat exchanger 67 by the second circulation pump 63, the heat medium cooled by the outdoor air in the air-heat medium heat exchanger 67 is circulated to the motor 65 for running, and the motor 65 for running is cooled by the outdoor air.

Incidentally, when the running motor temperature Tm is lower than the predetermined value T2 in Step S6, the air conditioning controller 32 proceeds to Step S17 to set the heat medium circulation circuit 60 of the temperature adjustment device 61 to the second circulation mode. If the air conditioning operation in this case is a heating operation, the state shown in FIG. 3 is obtained, and if the air conditioning operation is a cooling operation, the state shown in FIG. 4 is obtained. In either case, since the heat medium heat-absorbed and cooled by the refrigerant in the heat medium flow passage 64A of the refrigerant-heat medium heat exchanger 64 is circulated to the battery 55, the battery 55 is cooled.

On the other hand, when the battery temperature Tb is lower than the predetermined value T1 in Step S5, the air conditioning controller 32 proceeds to Step S10, and this time determines whether or not the battery temperature Tb is less than or equal to a predetermined value T3. Incidentally, the predetermined value T3 is a predetermined low temperature lower than the predetermined value T1, and Tb≤T3 indicates a situation in which the battery 55 needs to be heated.

When the battery temperature Tb is less than or equal to the predetermined value T3 in Step S10, the air conditioning controller 32 proceeds to Step S11 to determine whether or not the heating capacity of the vehicle interior by the radiator 4 is insufficient in the heating operation. Then, when the heating capacity of the vehicle interior by the radiator 4 in the heating operation is insufficient in Step S11, the air conditioning controller 32 proceeds to Step S12 where the heat medium circulation circuit 60 of the temperature adjustment device 61 is set to the second circulation mode (FIG. 3), and after that, the first circulation pump 62 is operated to energize the heat medium heating heater 66 to generate heat.

Consequently, the heat medium heated by the heat medium heating heater 66 is circulated to the battery 55, and the battery 55 is heated. Further, the heat medium passed through the battery 55 is then circulated in the heat medium flow passage 64A of the refrigerant-heat medium heat exchanger 64, and the refrigerant absorbs heat from this heat medium. The absorbed heat of the heat medium heating heater 66 is transferred to the radiator 4 by the refrigerant and is used for heating assistance in the vehicle interior.

When the heating capacity is not insufficient in Step S11, the air conditioning controller 32 proceeds to Step S13 where the heat medium circulation circuit 60 of the temperature adjustment device 61 is set to the fifth circulation mode (FIG. 7), the first circulation pump 62 is operated, and the heat medium heating heater 66 is energized to generate heat. Thus, the heat medium heated by the heat medium heating heater 66 is circulated to the battery 55, so that the battery 55 is heated.

When the battery temperature Tb is higher than the predetermined value T3 in Step S10 (T3<Tb<T1), the air conditioning controller 32 proceeds to step S14. In Step S14, the air conditioning controller 32 determines whether or not the running motor temperature Tm detected by the running motor temperature sensor 78 is higher than or equal to a predetermined value T4. Incidentally, the predetermined value T4 is also a relatively high temperature as the heat generation temperature of the motor 65 for running and is taken to be T4>T1.

When the running motor temperature Tm is higher than or equal to the predetermined value T4 in Step S14, the air conditioning controller 32 proceeds to Step S15 to judge the current air conditioning operation of the heat pump device IP. Then, when the current air conditioning operation is the heating operation in Step S15, the air conditioning controller proceeds to Step S16 to set the heat medium circulation circuit 60 of the temperature adjustment device 61 to the fourth circulation mode (FIG. 6) and operate the second circulation pump 63.

Thus, the heat medium heat-absorbed and cooled by the refrigerant in the heat medium flow passage 64A of the refrigerant-heat medium heat exchanger 64 is circulated to the motor 65 for running (uncirculated to the battery 55). Then, the heat medium exchanges heat with the motor 65 for running to recover waste heat from the motor 65 for running, and hence the motor 65 for running itself is cooled. The waste heat recovered from the motor 65 for running is transferred to the radiator 4 by the refrigerant to assist the heating.

When the current air conditioning operation is the cooling operation in Step S15, or when the heat pump device IP is stopped (compressor 2 is stopped), the air conditioning controller proceeds to Step S18 to set the heat medium circulation circuit 60 of the temperature adjustment device 61 to the third circulation mode (FIG. 5) and operate the second circulation pump 63. Thus, since the heat medium is circulated between the motor 65 for running and the air-heat medium heat exchanger 67, the heat medium cooled by the outdoor air in the air-heat medium heat exchanger 67 is circulated to the motor 65 for running, so that the motor 65 for running is cooled by the outdoor air.

Incidentally, when the running motor temperature Tm is lower than the predetermined value T4 in Step S14, that is, when T3<Tb<T1 and Tm<T4, the air conditioning controller 32 proceeds to Step S19 to stop the temperature adjustment device 61 (stop the circulation pumps 62 and 63 and also deenergize the heat medium heating heater 66).

As described in detail above, the temperature adjustment device 61 of the vehicle-mounted heat-generating equipment of the present invention includes the battery 55 (low heat-generating equipment) mounted on the vehicle, the heat medium circulation circuit 60 for circulating the heat medium to the battery 55 and the motor 65 for running when adjusting the temperature of the motor 65 for running (high heat-generating equipment) higher in the heat generation temperature than the battery 55, and the refrigerant-heat medium heat exchanger 64 (cooling unit) for cooling the heat medium circulated in the heat medium circulation circuit 60. Therefore, the refrigerant-heat medium heat exchanger 64 can cool the battery 55 and the motor 65 for running via the heat medium and adjust their temperatures.

Here, when the heat medium cooled by the refrigerant-heat medium heat exchanger 64 is made to flow from the motor 65 for running to the battery 55, the heat medium whose temperature has risen due to heat exchange by the motor 65 for running flows to the battery 55. There is therefore a risk that the battery 55 will be heated by the motor 65 for running via the heat medium. However, in the present invention, the heat medium cooled by the refrigerant-heat medium heat exchanger 64 passes through the battery 55 and then flows to the motor 65 for running, so that such a problem is solved, and both the battery 55 and the motor 65 for running can be cooled without hindrance by the single refrigerant-heat medium heat exchanger 64.

Also, in the embodiment, the temperature adjustment device 61 is provided with the first bypass passage 68K for bypassing the motor 65 for running and allowing the heat medium passing through the battery 55 to flow through the refrigerant-heat medium heat exchanger 64, and the first three-way valve 81 and the fourth three-way valve 84 for changing whether the heat medium passed through the battery 55 is made to flow through the motor 65 for running or the heat medium is made to flow in the first bypass passage 68K. The air conditioning controller 32 is configured to be capable of executing the first circulation mode in which after the heat medium cooled by the refrigerant-heat medium heat exchanger 64 is made to flow through the battery 55, the heat medium is made to flow through the motor 65 for running, and the second circulation mode in which after the heat medium cooled by the refrigerant-heat medium heat exchanger 64 is made to flow through the battery 55, the heat medium is made to flow in the first bypass passage 68K. Therefore, when there is a need to cool both the battery 55 and the motor 65 for running by the refrigerant-heat medium heat exchanger 64, the air conditioning controller executes the first circulation mode. Thus, when there is a need to cool the battery 55 and there is no need to cool the motor 65 for running, the air conditioning controller executes the second circulation mode, whereby it becomes possible to cool only the battery 55 by the refrigerant-heat medium heat exchanger 64 and effectively adjust the temperatures of the battery 55 and the motor 65 for running.

Further, in the embodiment, the air-heat medium heat exchanger 67 for exchanging heat between the outdoor air and the heat medium, and the second three-way valve 82 for changing whether the heat medium passing through the motor 65 for running is made to flow through the refrigerant-heat medium heat exchanger 64 or the heat medium is made to flow through the air-heat medium heat exchanger 67 are provided in the temperature adjustment device 61. The air conditioning controller 32 is configured to be capable of executing the third circulation mode to circulate the heat medium between the motor 65 for running and the air-heat medium heat exchanger 67. Therefore, as in the embodiment, when there is a need to perform cooling of the motor 65 for running in a state in which the temperature of the battery 55 is adjusted by the refrigerant-heat medium heat exchanger 64 in the second circulation mode, the air conditioning controller executes even the third circulation mode (second circulation mode+third circulation mode), thereby making it possible to cool the motor 65 for running by the outdoor air through the heat medium.

Further, in the embodiment, the temperature adjustment device 61 is provided with the second bypass passage 68U for bypassing the battery 55 and allowing the heat medium passing through the refrigerant-heat medium heat exchanger 64 to flow through the motor 65 for running, and the third three-way valve 83 for changing whether the heat medium passed through the refrigerant-heat medium heat exchanger 64 is made to flow through the battery 55 or the heat medium is made to flow in the second bypass passage 68U. The air conditioning controller 32 is configured to be capable of executing the fourth circulation mode to circulate the heat medium between the motor 65 for running and the refrigerant-heat medium heat exchanger 64. Therefore, when there is a need to cool the motor 65 for running and there is no need to cool the battery 55, the air conditioning controller executes the fourth circulation mode, whereby it becomes possible to cool only the motor 65 for running by the refrigerant-heat medium heat exchanger 64.

Further, in the embodiment, since the temperature adjustment device 61 is provided with the heat medium heating heater 66 for heating the heat medium flowing into the battery 55, the heat medium heating heater 66 heats the heat medium flowing into the battery 55, thereby making it possible to heat the battery 55. Thus, it becomes possible to adjust the temperature of the battery 55 to an appropriate temperature in an environment where the temperature of the battery 55 becomes low.

In this case, in the embodiment, the temperature adjustment device 61 is provided with the third bypass passage 68M bypassing the first bypass passage 68K and the refrigerant-heat medium heat exchanger 64, and the fourth three-way valve 84 for changing whether the heat medium passed through the battery 55 is made to flow through the first bypass passage 68K or the heat medium is made to flow through the third bypass passage 68M. The air conditioning controller 32 is configured to be capable of executing the fifth circulation mode to circulate the heat medium between the battery 55 and the heat medium heating heater 66. Therefore, the fifth circulation mode is executed to thereby make it possible to smoothly heat the battery 55 by the heat medium heating heater 66.

Further, in the embodiment, the heater core 23 for heating the air supplied to the vehicle interior is provided, and the temperature adjustment device 61 is provided with the fourth bypass passage 68V for bypassing the battery 55 and allowing the heat medium passed through the heat medium heating heater 66 to flow into the heater core 23, and the fifth three-way valve 87 for changing whether the heat medium passing through the heat medium heating heater 66 is made to flow through the battery 55 or the heat medium is made to flow through the fourth bypass passage 68V. The air conditioning controller 32 is configured to be capable of executing the sixth circulation mode to circulate the heat medium between the heater core 23 and the heat medium heating heater 66. Therefore, when there is no need to heat the battery 55, the heat medium heated by the heat medium heating heater 66 is circulated to the heater core 23 by the sixth circulation mode, thereby making is possible to heat the vehicle interior by the heat medium heating heater 66 through the heat medium.

In addition, in the embodiment, the refrigerant circuit R having the compressor 2 which compresses the refrigerant, the radiator 4 and the outdoor heat exchanger 7 for letting the refrigerant discharged from the compressor 2 radiate heat, and the refrigerant-heat medium heat exchange 64 which lets the radiated refrigerant absorb heat is provided, and the heat medium is cooled by this refrigerant-heat medium heat exchanger 64. Therefore, it becomes possible to smoothly cool the battery 55 and the motor 65 for running by the heat pump operation using the refrigerant circuit R.

Then, in the embodiment, the temperature adjustment device 61 is provided in the vehicle air conditioner 1 which includes the refrigerant circuit R having the compressor 2 which compresses the refrigerant, the radiator 4 for letting the refrigerant radiate heat to heat the air supplied to the vehicle interior, and the refrigerant-heat medium heat exchanger 64 for letting the refrigerant absorb heat to cool the heat medium, and which lets the refrigerant discharged from the compressor 2 radiate heat in the radiator 4 to heat the vehicle interior. In the heating operation, the air conditioning controller 32 allows at least a part of the refrigerant from which the heat has been radiated in the radiator 4 to flow through the refrigerant-heat medium heat exchanger 64 and executes the first circulation mode, the second circulation mode, or the fourth circulation mode. In the first circulation mode, the waste heat is recovered from both of the battery 55 and the motor 65 for running, in the second circulation mode, the waste heat is recovered only from the battery 55, and in the fourth circulation mode, the waste heat is recovered only from the motor 65 for running to be transferred to the radiator 4, thereby making it possible to heat the vehicle interior.

Also, the heat medium is heated by the heat medium heating heater 66, and the second circulation mode is executed, whereby the heat from the heat medium heating heater 66 can also be transferred to the radiator 4 and contribute to the heating of the vehicle interior.

Further, in the embodiment, the refrigerant circuit R of the vehicle air conditioner 1 is provided with the heat absorber 9 for letting the refrigerant absorb heat to cool the air supplied to the vehicle interior, and the outdoor heat exchanger 7 provided outside the vehicle interior, thereby making it possible to execute the cooling operation of letting the refrigerant discharged from the compressor 2 radiate heat in the outdoor heat exchanger 7, decompressing the refrigerant from which the heat has been radiated, and then letting the refrigerant absorb heat in the heat absorber 9 to cool the vehicle interior. In the cooling operation, the air conditioning controller 32 allows at least a part of the refrigerant from which the heat has been radiated in the outdoor heat exchanger 7 to flow through the refrigerant-heat medium heat exchanger 64 and executes the second circulation mode. Therefore, the cooling of the battery 55 can also be performed while performing the cooling of the vehicle interior.

Incidentally, in the embodiment, the cooling unit is configured by the refrigerant-heat medium heat exchanger 64 of the heat pump device HP having the refrigerant circuit R, but the inventions of claims 1 to 8 are not limited thereto. For example, the cooling unit in the present invention may be configured by an electronic cooling device such as a Peltier element or the like. In that case, it is not necessary to provide the temperature adjustment device 61 of the present invention in the vehicle air conditioner 1 (inventions other than claims 9 and 10).

Further, the configuration of the air conditioning controller 32 described in the embodiment, and the configurations of the heat pump device HP and the temperature adjustment device 61 in the vehicle air conditioner 1 are not limited thereto, and needless to say can be changed within the scope not departing from the spirit of the present invention.

### DESCRIPTION OF REFERENCE NUMERALS

1 vehicle air conditioner
2 compressor
4 radiator (heat exchanger for radiation)
6 outdoor expansion valve
7 outdoor heat exchanger (heat exchanger for radiation)
8 indoor expansion valve
9 heat absorber
21, 22 solenoid valve
23 heater core
32 air conditioning controller (control device)
55 battery (low heat-generating equipment)
61 temperature adjustment device
62 first circulation pump (circulation device)
63 second circulation pump (circulation device)
64 refrigerant-heat medium heat exchanger (cooling unit)
65 motor for running
66 heat medium heating heater (heating unit)
67 air-heat medium heat exchanger
68 heat medium pipe
68K first bypass passage
68M third bypass passage
68U second bypass passage
68V fourth bypass passage
72 branch pipe
73 auxiliary expansion valve
81 first three-way valve (first flow passage changing device, fourth flow passage changing device)
82 second three-way valve (second flow passage changing device)
83 third three-way valve (third flow passage changing device)
84 fourth three-way valve (first flow passage changing device, fourth flow passage changing device)
87 fifth three-way valve (fifth flow passage changing device)

1. A temperature adjustment device for vehicle-mounted heat-generating equipment, for adjusting the temperatures of low heat-generating equipment mounted on a vehicle and high heat-generating equipment higher in heat generation temperature than the low heat-generating equipment, comprising:
a heat medium circulation circuit to circulate a heat medium through the low heat-generating equipment and the high heat-generating equipment; and
a cooling unit to cool the heat medium circulating through the heat medium circulation circuit,
wherein the heat medium cooled in the cooling unit flows through the low heat-generating equipment and then flows to the high heat-generating equipment.

2. The temperature adjustment device for the vehicle-mounted heat-generating equipment according to claim 1, including:
a first bypass passage to bypass the high heat-generating equipment to allow the heat medium passed through low heat-generating equipment to flow to the cooling unit,
a first flow passage changing device to change whether the heat medium passed through the low heat-generating equipment is made to flow to the high heat-generating equipment or made to flow through the first bypass passage, and
a control device to control the first flow passage changing device,
wherein the control device includes:
a first circulation mode in which the heat medium cooled by the cooling unit is passed through the low heat-generating equipment and then passed through the high heat-generating equipment, and
a second circulation mode in which the heat medium cooled by the cooling unit is passed through the low heat-generating equipment and then passed through the first bypass passage.

3. The temperature adjustment device for the vehicle-mounted heat-generating equipment according to claim 2, including:
an air-heat medium heat exchanger to exchange heat between outdoor air and the heat medium, and
a second flow passage changing device controlled by the control device and to change whether the heat medium passed through the high heat-generating equipment is made to flow to the cooling unit or made to flow to the air-heat medium heat exchanger,
wherein the control device has a third circulation mode to circulate the heat medium between the high heat-generating equipment and the air-heat medium heat exchanger.

4. The temperature adjustment device for the vehicle-mounted heat-generating equipment according to claim 2, including:
a second bypass passage to bypass the low heat-generating equipment to allow the heat medium passed through the cooling unit to flow to the high heat-generating equipment, and
a third flow passage changing device controlled by control device and to change whether the heat medium passed through the cooling unit is made to flow to the low heat-generating equipment or made to flow through the second bypass passage,
wherein the control device has a fourth circulation mode to circulate the heat medium between the high heat-generating equipment and the cooling unit.

5. The temperature adjustment device for the vehicle-mounted heat-generating equipment according to claim 2, including a heating unit controlled by the control device and to heat the heat medium flowing into the low heat-generating equipment.

6. The temperature adjustment device for the vehicle-mounted heat-generating equipment according to claim 5, including:
a third bypass passage to bypass the first bypass passage and the cooling unit, and
a fourth flow passage changing device controlled by the control device and to change whether the heat medium passed through the low heat-generating equipment is made to flow through the first bypass passage or made to flow through the third bypass passage,
wherein the control device has a fifth circulation mode to circulate the heat medium between the low heat-generating equipment and the heating unit.

7. The temperature adjustment device for the vehicle-mounted heat-generating equipment according to claim 5, including:
a heater core to heat air supplied to a vehicle interior,
a fourth bypass passage to bypass the low heat-generating equipment to allow the heat medium passed through the heating unit to flow to the heater core, and
a fifth flow passage changing device controlled by control device and to change whether the heat medium passed through the heating unit is made to flow to the low heat-generating equipment or made to flow through the fourth bypass passage,
wherein the control device has a sixth circulation mode to circulate the heat medium between the heater core and the heating unit.

8. The temperature adjustment device for the vehicle-mounted heat-generating equipment according to claim 1, including a refrigerant circuit having:
a compressor to compress a refrigerant,
a heat exchanger for radiation to let the refrigerant discharged from the compressor radiate heat, and
a refrigerant-heat medium heat exchanger as the cooling unit to let the refrigerant from which the heat has been radiated in the heat exchanger for radiation, absorb heat to thereby cool the heat medium.

9. A vehicle air conditioner having a temperature adjustment device for vehicle-mounted heat-generating equipment according to either claim 2, comprising a refrigerant circuit including:
a compressor to compress a refrigerant;
a radiator to let the refrigerant radiate heat to heat air supplied to a vehicle interior; and
a refrigerant-heat medium heat exchanger as the cooling unit to let the refrigerant absorb heat to cool the heat medium,
wherein the control device makes it possible to execute a heating operation of letting the refrigerant discharged from the compressor radiate heat in the radiator to heat the vehicle interior, and
wherein in the heating operation, the control device allows at least a part of the refrigerant from which the heat has been radiated in the radiator to flow through the refrigerant-heat medium heat exchanger and executes the first circulation mode, the second circulation mode, or the fourth circulation mode.

10. A vehicle air conditioner having a temperature adjustment device for vehicle-mounted heat-generating equipment according to claim 2, comprising a refrigerant circuit including:
a compressor to compress a refrigerant;
a heat absorber to let the refrigerant absorb heat to cool air supplied to a vehicle interior;
an outdoor heat exchanger provided outside the vehicle interior; and
a refrigerant-heat medium heat exchanger as the cooling unit to let the refrigerant absorb heat to cool the heat medium,
wherein the control device makes it possible to execute a cooling operation of letting the refrigerant discharged from the compressor radiate heat in the outdoor heat exchanger, decompressing the refrigerant from which the heat has been radiated, and then letting the refrigerant absorb heat in the heat absorber to cool the vehicle interior, and
wherein in the cooling operation, the control device allows at least a part of the refrigerant from which the heat has been radiated in the outdoor heat exchanger to flow through the refrigerant-heat medium heat exchanger and executes the second circulation mode.

11. The temperature adjustment device for the vehicle-mounted heat-generating equipment according to claim 3, including:
a second bypass passage to bypass the low heat-generating equipment to allow the heat medium passed through the cooling unit to flow to the high heat-generating equipment, and
a third flow passage changing device controlled by control device and to change whether the heat medium passed through the cooling unit is made to flow to the low heat-generating equipment or made to flow through the second bypass passage,
wherein the control device has a fourth circulation mode to circulate the heat medium between the high heat-generating equipment and the cooling unit.

12. The temperature adjustment device for the vehicle-mounted heat-generating equipment according to claim 3, including a heating unit controlled by the control device and to heat the heat medium flowing into the low heat-generating equipment.

13. The temperature adjustment device for the vehicle-mounted heat-generating equipment according claim 4, including a heating unit controlled by the control device and to heat the heat medium flowing into the low heat-generating equipment.

14. The temperature adjustment device for the vehicle-mounted heat-generating equipment according to claim 6, including:
a heater core to heat air supplied to a vehicle interior,
a fourth bypass passage to bypass the low heat-generating equipment to allow the heat medium passed through the heating unit to flow to the heater core, and
a fifth flow passage changing device controlled by control device and to change whether the heat medium passed through the heating unit is made to flow to the low heat-generating equipment or made to flow through the fourth bypass passage,
wherein the control device has a sixth circulation mode to circulate the heat medium between the heater core and the heating unit.

15. The temperature adjustment device for the vehicle-mounted heat-generating equipment according claim 2, including a refrigerant circuit having:
a compressor to compress a refrigerant,
a heat exchanger for radiation to let the refrigerant discharged from the compressor radiate heat, and
a refrigerant-heat medium heat exchanger as the cooling unit to let the refrigerant from which the heat has been radiated in the heat exchanger for radiation, absorb heat to thereby cool the heat medium.

16. The temperature adjustment device for the vehicle-mounted heat-generating equipment according to claim 3, including a refrigerant circuit having:
a compressor to compress a refrigerant,
a heat exchanger for radiation to let the refrigerant discharged from the compressor radiate heat, and
a refrigerant-heat medium heat exchanger as the cooling unit to let the refrigerant from which the heat has been radiated in the heat exchanger for radiation, absorb heat to thereby cool the heat medium.

17. The temperature adjustment device for the vehicle-mounted heat-generating equipment according to claim 5, including a refrigerant circuit having:
a compressor to compress a refrigerant,
a heat exchanger for radiation to let the refrigerant discharged from the compressor radiate heat, and
a refrigerant-heat medium heat exchanger as the cooling unit to let the refrigerant from which the heat has been radiated in the heat exchanger for radiation, absorb heat to thereby cool the heat medium.

18. The temperature adjustment device for the vehicle-mounted heat-generating equipment according to claim 7, including a refrigerant circuit having:
a compressor to compress a refrigerant,
a heat exchanger for radiation to let the refrigerant discharged from the compressor radiate heat, and
a refrigerant-heat medium heat exchanger as the cooling unit to let the refrigerant from which the heat has been radiated in the heat exchanger for radiation, absorb heat to thereby cool the heat medium.

19. A vehicle air conditioner having a temperature adjustment device for vehicle-mounted heat-generating equipment according to claim 4, comprising a refrigerant circuit including:
a compressor to compress a refrigerant;
a radiator to let the refrigerant radiate heat to heat air supplied to a vehicle interior; and
a refrigerant-heat medium heat exchanger as the cooling unit to let the refrigerant absorb heat to cool the heat medium,
wherein the control device makes it possible to execute a heating operation of letting the refrigerant discharged from the compressor radiate heat in the radiator to heat the vehicle interior, and
wherein in the heating operation, the control device allows at least a part of the refrigerant from which the heat has been radiated in the radiator to flow through the refrigerant-heat medium heat exchanger and executes the first circulation mode, the second circulation mode, or the fourth circulation mode.

20. A vehicle air conditioner having a temperature adjustment device for vehicle-mounted heat-generating equipment according to claim 5, comprising a refrigerant circuit including:
a compressor to compress a refrigerant;
a radiator to let the refrigerant radiate heat to heat air supplied to a vehicle interior; and
a refrigerant-heat medium heat exchanger as the cooling unit to let the refrigerant absorb heat to cool the heat medium,
wherein the control device makes it possible to execute a heating operation of letting the refrigerant discharged from the compressor radiate heat in the radiator to heat the vehicle interior, and
wherein in the heating operation, the control device allows at least a part of the refrigerant from which the heat has been radiated in the radiator to flow through the refrigerant-heat medium heat exchanger and executes the first circulation mode, the second circulation mode, or the fourth circulation mode.
